(19) United States
(12) Patent Application Publication
(10) Pub. No.: US 2026/0019002 A1
(43) Pub. Date: Jan. 15, 2026

(54) POWER CONVERTER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: RYOTA KOJIMA, Nisshin-shi (JP)

(21) Appl. No.: 19/175,255

(22) Filed: Apr. 10, 2025

(30) Foreign Application Priority Data
Jul. 11, 2024 (JP) 2024-111968

(51) Int. Cl. H02M 3/335; H02M 1/00

(52) U.S. Cl. CPC H02M 3/33592; H02M 1/0048; H02M 3/33573

(57) ABSTRACT

A power converter includes a converter, a transformer, a rectifying element, a detector, and a controller. The converter converts a DC voltage into an AC voltage, the DC voltage supplied from a DC power supply. The transformer steps up or down the AC voltage. The rectifying element is a transistor, and rectifies the AC voltage that is stepped up or down by the transformer. The detector detects a transformer voltage between the transformer and the rectifying element. The controller turns off the rectifying element that is in an on-state, based on the transformer voltage.

### CROSS REFERENCE TO RELATED APPLICATION

This application is based on Japanese Patent Application No. 2024-111968 filed on Jul. 11, 2024, the disclosure of which is incorporated herein by reference.

### TECHNICAL FIELD

The present disclosure relates to a power converter.

### BACKGROUND

A DC-DC converter may generate a drive signal for a rectifying switching element in a synchronous rectification circuit by predicting a secondary-side current from a primary-side current and controlling an off-timing based on the predicted current.

### SUMMARY

The present disclosure describes a power converter that incudes a converter, a detector, a rectifying element, a transformer and a controller.

### BRIEF DESCRIPTION OF DRAWINGS

FIG. 1 is a circuit diagram of a power converter according to a first embodiment.

FIG. 2 is a configuration diagram of a detection circuit in the power converter.

FIG. 3 is a timing chart showing an operation of the power converter.

FIG. 4 is a circuit showing current flow when the power converter is operating.

FIG. 5 is a circuit showing current flow when the power converter is operating.

FIG. 6 is a circuit showing current flow when the power converter is operating.

FIG. 7 is a circuit showing current flow when the power converter is operating.

FIG. 8 is a circuit showing current flow when the power converter is operating.

FIG. 9 is a circuit showing current flow when the power converter is operating.

FIG. 10 is a flowchart showing processing of a control circuit in the power converter.

FIG. 11 is a timing chart for explaining the processing of the control circuit.

FIG. 12 is a flowchart showing processing of a control circuit in a power converter according to a second embodiment.

FIG. 13 is a timing chart for explaining the processing of the control circuit.

FIG. 14 is a timing chart for explaining the processing of a control circuit in a power converter according to a third embodiment.

FIG. 15 is a timing chart for explaining the processing of the control circuit.

FIG. 16 is a timing chart for explaining the processing of a control circuit in a power converter according to a fourth embodiment.

FIG. 17 is a timing chart for explaining the processing of the control circuit.

FIG. 18 is a flowchart showing the processing of a control circuit in a power converter according to a fifth embodiment.

FIG. 19 is a flowchart showing the processing of a control circuit in a power converter according to a sixth embodiment.

FIG. 20 is a timing chart for explaining the processing of a control circuit in a power converter according to a seventh embodiment.

FIG. 21 is a circuit diagram of a power converter according to an eighth embodiment.

FIG. 22 is a circuit diagram of a power converter according to a ninth embodiment.

FIG. 23 is a circuit diagram of a power converter according to a tenth embodiment.

FIG. 24 is a circuit diagram of a power converter according to an eleventh embodiment.

### DETAILED DESCRIPTION

In a DC-DC converter, a current may flow through a primary-side transformer as well as through coils connected to the transformer and a parasitic inductance of the transformer. Additionally, due to manufacturing variations and other factors, coils and transformers may exhibit variations in characteristics such as reactance. As a result, the primary-side current may vary between different DC-DC converters. Therefore, the accuracy of predicting the secondary-side current may decrease. Consequently, the off-timing corresponding to the predicted current and other parameters may vary. Therefore, in the DC-DC converter described above, the variation in power loss due to the rectifying switching element may become significant. For this reason, in the DC-DC converter described above, the power loss due to the rectifying switching element may increase.

According to an aspect of the present disclosure, a power converter includes a converter, a transformer, a rectifying element, a detector, and a controller. The converter converts a DC voltage into an AC voltage, the DC voltage supplied from a DC power supply. The transformer steps up or down the AC voltage. The rectifying element is a transistor, and rectifies the AC voltage that is stepped up or down by the transformer. The detector detects a transformer voltage between the transformer and the rectifying element. The controller turns off the rectifying element that is in an on-state, based on the transformer voltage.

As a result, the rectifying element in the on-state turns off without using the current flowing through the primary side corresponding to the conversion unit and the transformer. Therefore, the influence of the variation in the current flowing through the primary side is suppressed, and the rectifying element in the on-state turns off. Therefore, the variation in the off-timing of the rectifying element in the on-state is suppressed. Additionally, by using the voltage between the transformer and the rectifying element, the power-loss period of the rectifying element can be shortened, allowing the rectifying element to be turned off. Thus, while suppressing the variation in the off-timing of the rectifying element in the on-state, the power-loss period can be shortened. Therefore, the power loss due to the rectifying element is suppressed.

Hereinafter, embodiments will be described with reference to the drawings. In the following embodiments, the same or equivalent portions are denoted by the same reference numerals, and the description thereof will be omitted.

### First Embodiment

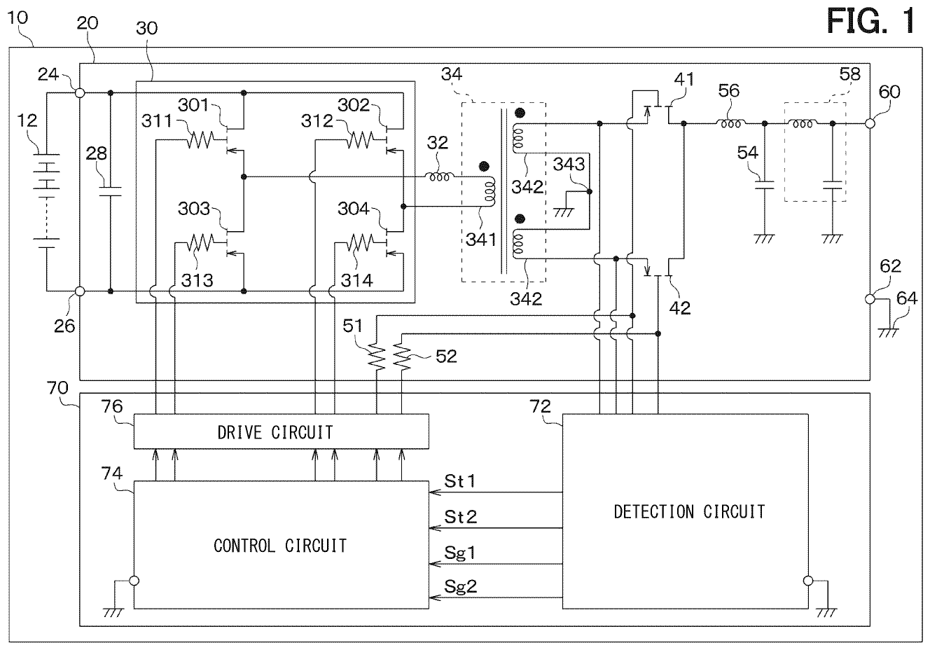

The power converter according to the present embodiment is, for example, a DC-DC converter for a vehicle, and suppresses power loss due to a rectifying element. As shown in FIG. 1, a power converter 10 includes a DC power supply 12, a main circuit 20, and a sub-circuit 70.

The DC power supply 12 is connected to the main circuit 20 which will be described later. In addition, the DC power supply 12 applies a relatively high DC voltage to the main circuit 20.

The main circuit 20 has a positive input terminal 24, a negative input terminal 26, an input capacitor 28, a conversion circuit 30, a magnetic component 32, a transformer 34, a first rectifying element 41, a first element adjusting resistor 51, a second rectifying element 42 and a second element adjusting resistor 52. Furthermore, the main circuit 20 has an output capacitor 54, a choke coil 56, a filter 58, an output terminal 60, a main circuit ground terminal 62, and a main circuit ground 64.

The positive input terminal 24 is connected to the positive electrode of the DC power supply 12. The negative input terminal 26 is connected to the negative electrode of the DC power supply 12.

One end of the input capacitor 28 is connected to the positive input terminal 24. The other end of the input capacitor 28 is connected to the negative input terminal 26. Furthermore, the input capacitor 28 smooths the DC voltage applied from the DC power supply 12 to the main circuit 20.

The conversion circuit 30 corresponds to a conversion unit or a converter, and is connected to one end and the other end of the input capacitor 28 and is connected in parallel to the DC power supply 12. The conversion circuit 30 is, for example, a full-bridge inverter circuit. Thus, the conversion circuit 30 includes a first transistor 301, a second transistor 302, a third transistor 303 and a fourth transistor 304. Furthermore, the conversion circuit 30 includes a first adjusting resistor 311, a second adjusting resistor 312, a third adjusting resistor 313 and a fourth adjusting resistor 314.

The first transistor 301, the second transistor 302, the third transistor 303, and the fourth transistor 304 are transistors such as FETs. The first transistor 301 and the third transistor 303 are connected in series and in parallel to the DC power supply 12. The second transistor 302 and the fourth transistor 304 are connected in series and are connected in parallel to the DC power supply 12. The first transistor 301, the second transistor 302, the third transistor 303 and the fourth transistor 304 are turned on and off based on a signal from a drive circuit 76, which will be described later. This converts the DC voltage from the DC power supply 12 into an AC voltage.

One end of the first adjusting resistor 311 is connected to the gate electrode of the first transistor 301. In addition, the first adjusting resistor 311 adjusts the voltage applied to the gate electrode of the first transistor 301.

One end of the second adjusting resistor 312 is connected to the gate electrode of the second transistor 302. Furthermore, the second adjusting resistor 312 adjusts the voltage applied to the gate electrode of the second transistor 302.

One end of the third adjusting resistor 313 is connected to the gate electrode of the third transistor 303. In addition, the third adjusting resistor 313 adjusts the voltage applied to the gate electrode of the third transistor 303.

One end of the fourth adjusting resistor 314 is connected to the gate electrode of the fourth transistor 304. Furthermore, the fourth adjusting resistor 314 adjusts the voltage applied to the gate electrode of the fourth transistor 304.

The magnetic component 32 is, for example, a coil. One end of the magnetic component 32 is connected to the conversion circuit 30. The other end of the magnetic component 32 is connected to a transformer 34 which will be described later. Therefore, the AC voltage converted by the conversion circuit 30 is applied to the magnetic component 32. The AC voltage converted by the conversion circuit 30 is applied to the transformer 34 via the magnetic component 32.

The transformer 34 has a primary winding 341 and a secondary winding 342. The primary winding 341 is connected to the conversion circuit 30. The secondary winding 342 is connected to the first rectifying element 41 and a second rectifying element 42 which will be described later. Additionally, the secondary winding 342 includes a center tap 343. The center tap 343 is connected to ground. The transformer 34 steps down the AC voltage applied from the conversion circuit 30 via the magnetic component 32 by the primary winding 341 and the secondary winding 342. Furthermore, the transformer 34 applies the stepped-down AC voltage to the first rectifying element 41 and the second rectifying element 42.

The first rectifying element 41 is, for example, an FET, and rectifies the current of the AC voltage stepped down by the transformer 34. Furthermore, the first rectifying element 41 performs synchronous rectification by being turned on during a period in which a current flows through the first rectifying element 41. As a result, the first rectifying element 41 suppresses the power loss occurring in the first rectifying element 41.

One end of the first element adjusting resistor 51 is connected to the gate electrode of the first rectifying element 41. Furthermore, the first element adjusting resistor 51 adjusts the voltage applied to the gate electrode of the first rectifying element 41.

The second rectifying element 42 is, for example, an FET, and rectifies the current of the AC voltage stepped down by the transformer 34. Additionally, the second rectifying element 42 is connected to the side of the secondary winding 342 opposite to the first rectifying element 41. For this reason, the second rectifying element 42 rectifies the current flowing in the opposite direction to the current flowing from the transformer 34 to the first rectifying element 41. Furthermore, the second rectifying element 42 performs synchronous rectification by turning on during the period when current is flowing through the second rectifying element 42. As a result, the second rectifying element 42 suppresses the power loss that occurs in the second rectifying element 42.

One end of the second element adjusting resistor 52 is connected to the gate electrode of the second rectifying element 42. Furthermore, the second element adjusting resistor 52 adjusts the voltage applied to the gate electrode of the second rectifying element 42.

One end of the output capacitor 54 is connected to a choke coil 56, which will be described later. The other end of the output capacitor 54 is connected to the ground.

One end of the choke coil 56 is connected to the drain electrode of the first rectifying element 41 and the drain electrode of the second rectifying element 42. Additionally, the choke coil 56, together with the output capacitor 54, smooths the current rectified by the first rectifying element 41 and the second rectifying element 42.

One end of the filter 58 is connected to one end of the output capacitor 54 and the other end of the choke coil 56. Furthermore, the filter 58 is, for example, a low-pass filter, and removes noise contained in the current smoothed by the choke coil 56.

The output terminal 60 is connected to the other end of the filter 58. The main circuit ground terminal 62 is connected to a main circuit ground 64. The main circuit ground 64 may also be referred to as a ground for the main circuit.

Additionally, the output terminal 60 outputs the voltage of the current that has passed through the filter 58 to the outside of the power converter 10. The outside of the power converter 10 is, for example, an auxiliary battery used for audio or the like of the vehicle. The auxiliary battery is charged by the voltage from the output terminal 60.

The main circuit 20 is configured as described above. Therefore, the positive input terminal 24, the negative input terminal 26, the input capacitor 28, the conversion circuit 30, the magnetic component 32 and the primary winding 341 correspond to the primary side of the main circuit 20. Furthermore, the secondary winding 342, the first rectifying element 41, the second rectifying element 42, the output capacitor 54, the choke coil 56, the filter 58 and the output terminal 60 correspond to the secondary side of the main circuit 20.

The sub-circuit 70 includes a detection circuit 72, a control circuit 74 and a drive circuit 76. Here, the voltage between the transformer 34 and the first rectifying element 41 is defined as a first transformer voltage Vt1. The voltage between the transformer 34 and the second rectifying element 42 is defined as a second transformer voltage Vt2. The voltage between the gate electrode and source electrode of the first rectifying element 41 is defined as a first gate voltage Vgs1. The voltage between the gate electrode and source electrode of the second rectifying element 42 is defined as a second gate voltage Vgs2.

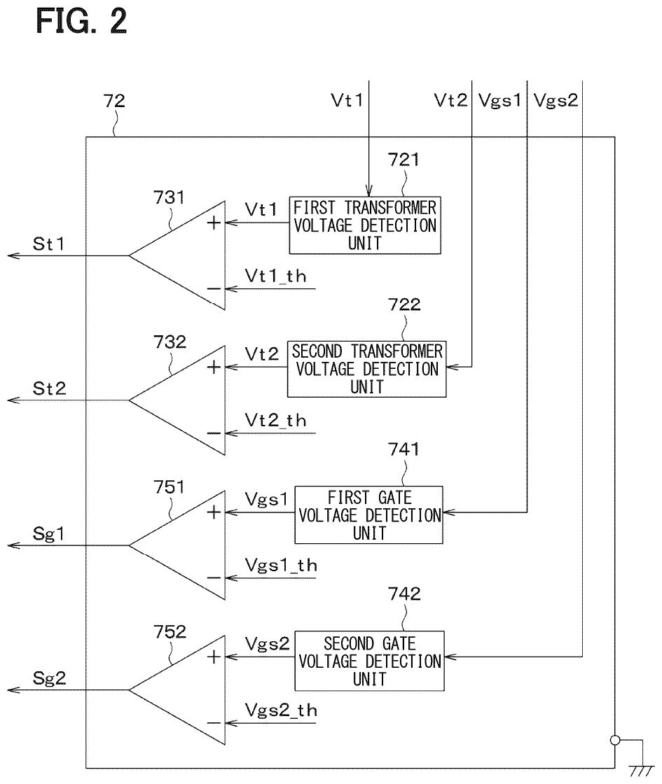

The detection circuit 72 corresponds to a detection unit or a detector, and includes a first transformer voltage detection unit 721, a first transformer voltage comparator 731, a second transformer voltage detection unit 722, and a second transformer voltage comparator 732, as shown in FIG. 2. Additionally, the detection circuit 72 includes a first gate voltage detection unit 741, a first gate voltage comparator 751, a second gate voltage detection unit 742, and a second gate voltage comparator 752.

The first transformer voltage detection unit 721 detects the first transformer voltage Vt1. Furthermore, the first transformer voltage detection unit 721 outputs the detected first transformer voltage Vt1 to the first transformer voltage comparator 731 described below.

The first transformer voltage Vt1 detected by the first transformer voltage detection unit 721 is input to the non-inverting input terminal of the first transformer voltage comparator 731. Additionally, the first transformer voltage threshold Vt1_th is input to the inverting input terminal of the first transformer voltage comparator 731. Accordingly, the first transformer voltage comparator 731 outputs a signal corresponding to the comparison result between the first transformer voltage Vt1 and the first transformer voltage threshold Vt1_th to the control circuit 74, described later, as the first transformer detection signal St1.

The second transformer voltage detection unit 722 detects the second transformer voltage Vt2. Furthermore, the second transformer voltage detection unit 722 outputs the detected second transformer voltage Vt2 to the second transformer voltage comparator 732, which will be described later.

The second transformer voltage Vt2 detected by the second transformer voltage detection unit 722 is provided to the non-inverting input terminal of the second transformer voltage comparator 732. Moreover, the second transformer voltage threshold Vt2_th is provided to the inverting input terminal of the second transformer voltage comparator 732. Therefore, the second transformer voltage comparator 732 outputs a signal according to the result of the comparison between the second transformer voltage Vt2 and the second transformer voltage threshold Vt2_th to the control circuit 74 described later as a second transformer detection signal St2.

The first gate voltage detector 741 detects the first gate voltage Vgs1. Furthermore, the first gate voltage detection unit 741 outputs the detected first gate voltage Vgs1 to a first gate voltage comparator 751, which will be described later.

The first gate voltage Vgs1 detected by the first gate voltage detection unit 741 is provided to the non-inverting input terminal of the first gate voltage comparator 751. Additionally, the first gate voltage threshold Vgs1_th is provided to the inverting input terminal of the first gate voltage comparator 751. Therefore, the first gate voltage comparator 751 outputs a signal according to the result of the comparison between the first gate voltage Vgs1 and the first gate voltage threshold Vgs1_th to the control circuit 74 described below as a first gate detection signal Sg1.

The second gate voltage detection unit 742 detects the second gate voltage Vgs2. Furthermore, the second gate voltage detection unit 742 outputs the detected second gate voltage Vgs2 to a second gate voltage comparator 752, which will be described later.

The second gate voltage Vgs2 detected by the second gate voltage detection unit 742 is provided to the non-inverting input terminal of the second gate voltage comparator 752. Moreover, the second gate voltage threshold Vgs2_th is provided to the inverting input terminal of the second gate voltage comparator 752. Therefore, the second gate voltage comparator 752 outputs a signal according to the result of the comparison between the second gate voltage Vgs2 and the second gate voltage threshold Vgs2_th to the control circuit 74 described below as a second gate detection signal Sg2.

With regard to FIG. 1, the control circuit 74 corresponds to a control unit or a controller and primarily includes a microcontroller or the like. It includes a CPU, ROM, flash memory, RAM, I/O, communication interfaces, and a bus line that connects these components. Furthermore, the control circuit 74 executes a program stored in the ROM of the control circuit 74. As a result, the control circuit 74 generates a signal to drive the conversion circuit 30. Specifically, the control circuit 74 generates signals to turn on and off the first transistor 301, the second transistor 302, the third transistor 303, and the fourth transistor 304. In addition, the control circuit 74 generates signals that turn on and off the first rectifying element 41 and the second rectifying element 42. Furthermore, the control circuit 74 acquires the first transformer detection signal St1, the second transformer detection signal St2, the first gate detection signal Sg1, and the second gate detection signal Sg2. In addition, the control circuit 74 generates signals to turn off the first rectifying element 41 and the second rectifying element 42, which are in the on-state, based on the acquired first transformer detection signal St1, second transformer detection signal St2, first gate detection signal Sg1, and second gate detection signal Sg2. Furthermore, the control circuit 74 outputs these generated signals to a drive circuit 76, which will be described later.

The drive circuit 76 is connected to the other ends of the first adjusting resistor 311, the second adjusting resistor 312, the third adjusting resistor 313, the fourth adjusting resistor 314, the first element adjusting resistor 51, and the second element adjusting resistor 52. In addition, the drive circuit 76 receives a signal from the control circuit 74.

The drive circuit 76 applies and stops the voltage application to the gate electrode of the first transistor 301 via the first adjusting resistor 311 based on a signal from the control circuit 74. This causes the first transistor 301 to be turned on and off. The drive circuit 76 applies and stops the application of a voltage to the gate electrode of the second transistor 302 via the second adjusting resistor 312 based on a signal from the control circuit 74. This causes the second transistor 302 to be turned on and off. The drive circuit 76 applies and stops the voltage application to the gate electrode of the third transistor 303 via the third adjusting resistor 313 based on a signal from the control circuit 74. This causes the third transistor 303 to be turned on and off. The drive circuit 76 applies and stops the voltage application to the gate electrode of the fourth transistor 304 via the fourth adjusting resistor 314 based on a signal from the control circuit 74. This causes the fourth transistor 304 to be turned on and off. The drive circuit 76 applies and stops the voltage application to the gate electrode of the first rectifying element 41 via the first element adjusting resistor 51 based on a signal from the control circuit 74. This causes the first rectifying element 41 to be turned on and off. The drive circuit 76 applies and stops the voltage application to the gate electrode of the second rectifying element 42 via the second element adjusting resistor 52 based on a signal from the control circuit 74. This causes the second rectifying element 42 to be turned on and off.

The power converter 10 of the first embodiment is configured as described above. Next, an operation of the electric power converter 10 will be described.

The first transistor 301 and the third transistor 303 are turned on and off in a complementary manner with a phase difference of 180°. The second transistor 302 and the fourth transistor 304 are turned on and off in a complementary manner with a phase difference of 180°. The first transistor 301 and the fourth transistor 304 are turned on and off out of phase with each other. Moreover, the second transistor 302 and the third transistor 303 are turned on and off with a phase difference.

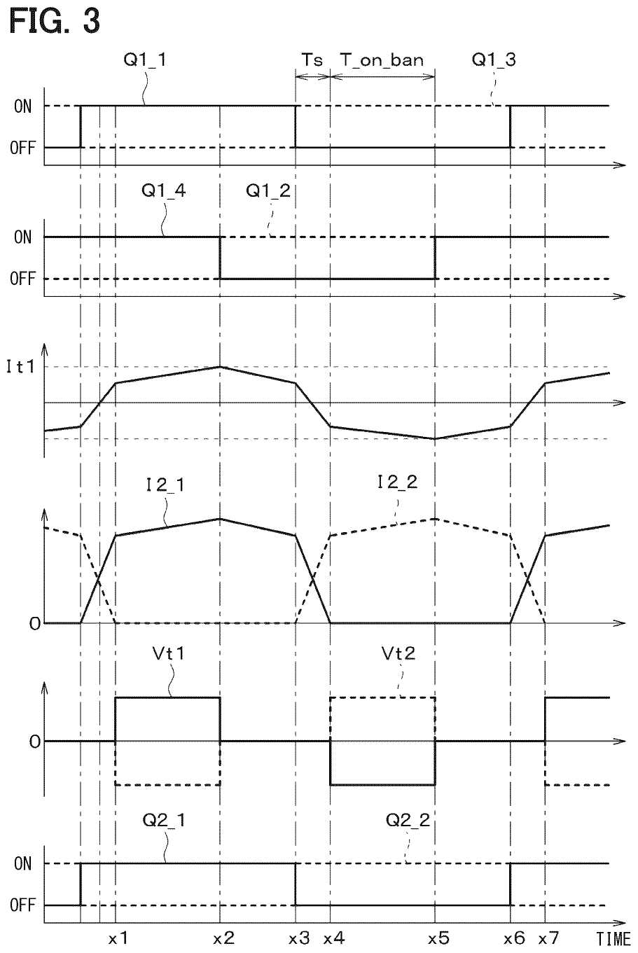

For example, at time x1 in the timing chart of FIG. 3, the control circuit 74 outputs a signal to the drive circuit 76 to turn on the first transistor 301. The drive circuit 76 applies a voltage to the gate electrode of the first transistor 301 via the first adjusting resistor 311. As a result, the first transistor 301 is turned on. At this time, the third transistor 303 is off. In the timing chart of FIG. 3, the on/off of the first transistor 301 is indicated by Q1_1 and a solid line. The on/off of the third transistor 303 is indicated by Q1_3 and the dashed line.

Furthermore, the control circuit 74 outputs a signal to the drive circuit 76 to turn on the fourth transistor 304. The drive circuit 76 applies a voltage to the gate electrode of the fourth transistor 304 via a fourth adjusting resistor 314. As a result, the fourth transistor 304 is turned on. Therefore, the second transistor 302 is turned off. In the timing chart of FIG. 3, the on/off of the second transistor 302 is indicated by Q1_2 and a dashed line. The on/off of the fourth transistor 304 is indicated by Q1_4 and a solid line.

In addition, the control circuit 74 outputs a signal to the drive circuit 76 to turn on the first rectifying element 41. The drive circuit 76 applies a voltage to the gate electrode of the first rectifying element 41 via the first element adjusting resistor 51. As a result, the first rectifying element 41 is turned on. At this time, the second rectifying element 42 is turned off. In the timing chart of FIG. 3, the on/off of the first rectifying element 41 is indicated by Q2_1 and a solid line. The on/off of the second rectifying element 42 is indicated by Q2_2 and a dashed line.

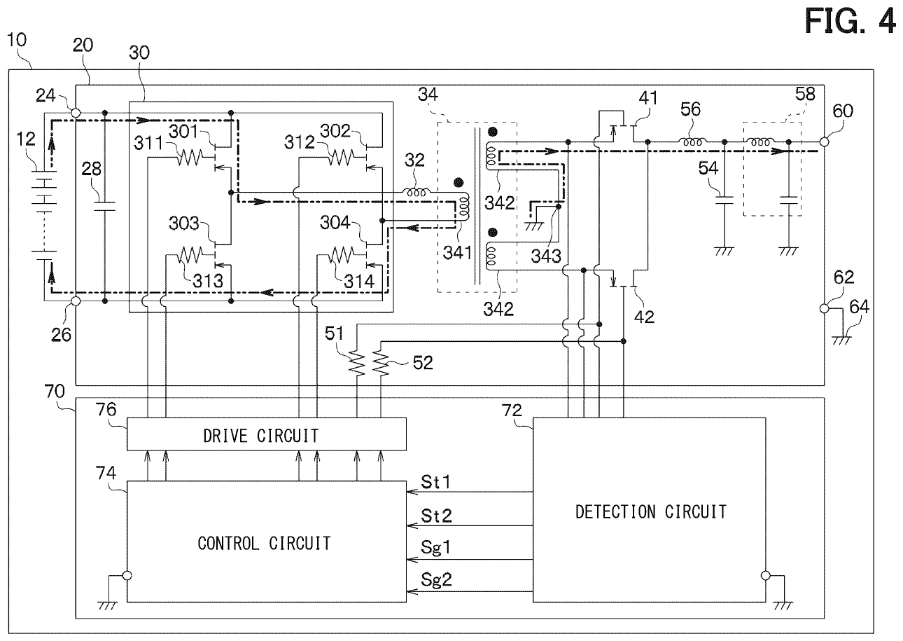

In the period from time x1 to time x2, the first transistor 301 and the fourth transistor 304 are on. Therefore, as shown in FIG. 4, a current flows from the positive electrode of the DC power supply 12 to the negative electrode of the DC power supply 12 via the first transistor 301, the magnetic component 32, the primary winding 341, and the fourth transistor 304. In FIG. 4, the current flow is indicated typically by a two-dot chain line.

Therefore, in the period from time x1 to time x2 in the timing chart of FIG. 3, the current flowing through the primary winding 341 increases. In the timing chart of FIG. 3, the current flowing through the primary winding 341 is indicated by It1 and a solid line. The direction of the current flowing from the positive terminal of the DC power supply 12 through the first transistor 301, the magnetic component 32, the primary winding 341, and the fourth transistor 304 to the negative terminal of the DC power supply 12 is defined as the positive direction of the current flowing through the primary winding 341.

Furthermore, as current flows through the primary winding 341, due to the turns ratio of the primary winding 341 and the secondary winding 342, and electromagnetic induction, a stepped-down current flows through the secondary winding 342, which has a lower voltage than the primary winding 341 through which a current flows. At this time, rectification is performed by the first rectifying element 41 and the second rectifying element 42.

Therefore, in the period from time x1 to time x2 in the timing chart of FIG. 3, the current flowing through the first rectifying element 41 increases. Moreover, no current flows through the second rectifying element 42. In the timing chart of FIG. 3, the current flowing through the first rectifying element 41 is indicated by 12_1 and a solid line. The current flowing through the second rectifying element 42 is indicated by 12_2 and a dashed line.

Furthermore, the current rectified by the first rectifying element 41 and the second rectifying element 42 is smoothed by the output capacitor 54 and the choke coil 56. Noise contained in the current smoothed by the output capacitor 54 and the choke coil 56 is removed by the filter 58. The voltage of the current that has passed through the filter 58 is output to the outside of the power converter 10 via the output terminal 60.

In the period from time x1 to time x2, the first transformer voltage Vt1 becomes a positive value. Furthermore, the second transformer voltage Vt2 becomes a negative value.

At time x2, the control circuit 74 outputs a signal to the drive circuit 76 to turn off the fourth transistor 304. The drive circuit 76 stops applying a voltage to the gate electrode of the fourth transistor 304. This causes the fourth transistor 304 to turn off. In addition, the control circuit 74 outputs a signal to the drive circuit 76 to turn on the second transistor 302. The drive circuit 76 applies a voltage to the gate electrode of the second transistor 302 via the second adjusting resistor 312. This causes the second transistor 302 to turn on. At this time, the first transistor 301 is on. The third transistor 303 is off. The first rectifying element 41 is on. The second rectifying element 42 is off.

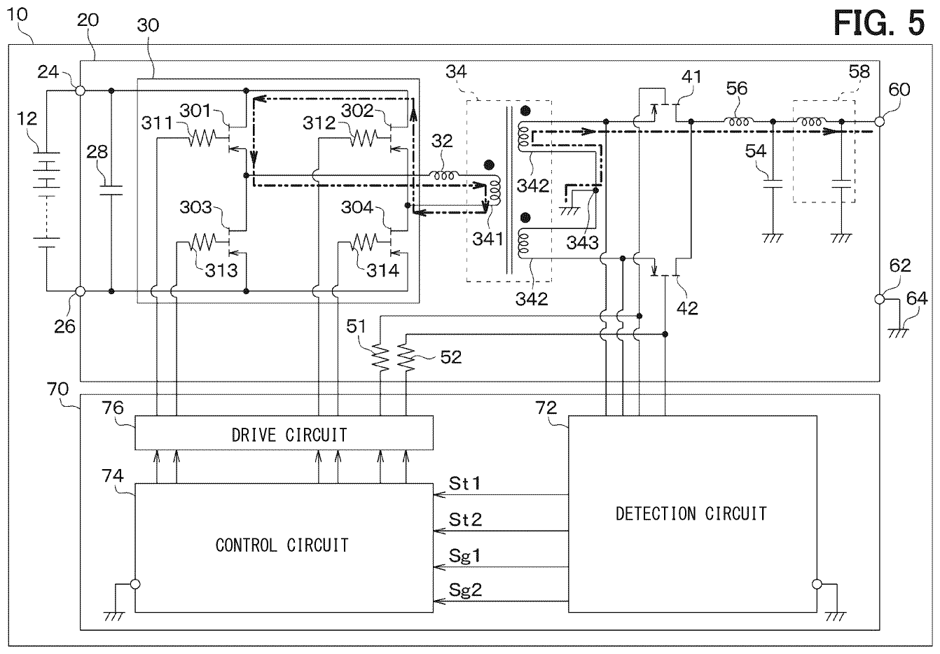

When the fourth transistor 304 turns off and the second transistor 302 turns on, as shown in FIG. 5, the current recirculates from the magnetic component 32 through the primary winding 341, the second transistor 302, and the first transistor 301 back to the magnetic component 32. It should be noted that in FIG. 5, the flow of current is schematically shown by a two-dot chain line.

As a result, the current flowing through the primary winding 341 decreases during the period from time x2 to time x3 in the timing chart of FIG. 3. Therefore, the current in the secondary winding 342 and the current flowing through the first rectifying element 41 decrease during the period from time x2 to time x3. Additionally, the first transformer voltage Vt1 and the second transformer voltage Vt2 become zero.

At time x3, the control circuit 74 outputs a signal to the drive circuit 76 to turn off the first transistor 301. The drive circuit 76 stops applying a voltage to the gate electrode of the first transistor 301. This causes the first transistor 301 to turn off. Furthermore, the control circuit 74 outputs a signal to the drive circuit 76 to turn on the third transistor 303. The drive circuit 76 applies a voltage to the gate electrode of the third transistor 303 via the third adjusting resistor 313. As a result, the third transistor 303 is turned on. At this time, the second transistor 302 is on. The fourth transistor 304 is off.

In addition, the control circuit 74 outputs a signal to the drive circuit 76 to turn off the first rectifying element 41. The drive circuit 76 stops applying a voltage to the gate electrode of the first rectifying element 41. As a result, the first rectifying element 41 is turned off.

Furthermore, the control circuit 74 outputs a signal to the drive circuit 76 to turn on the second rectifying element 42. The drive circuit 76 applies a voltage to the gate electrode of the second rectifying element 42 via the second element adjusting resistor 52. This turns on the second rectifying element 42.

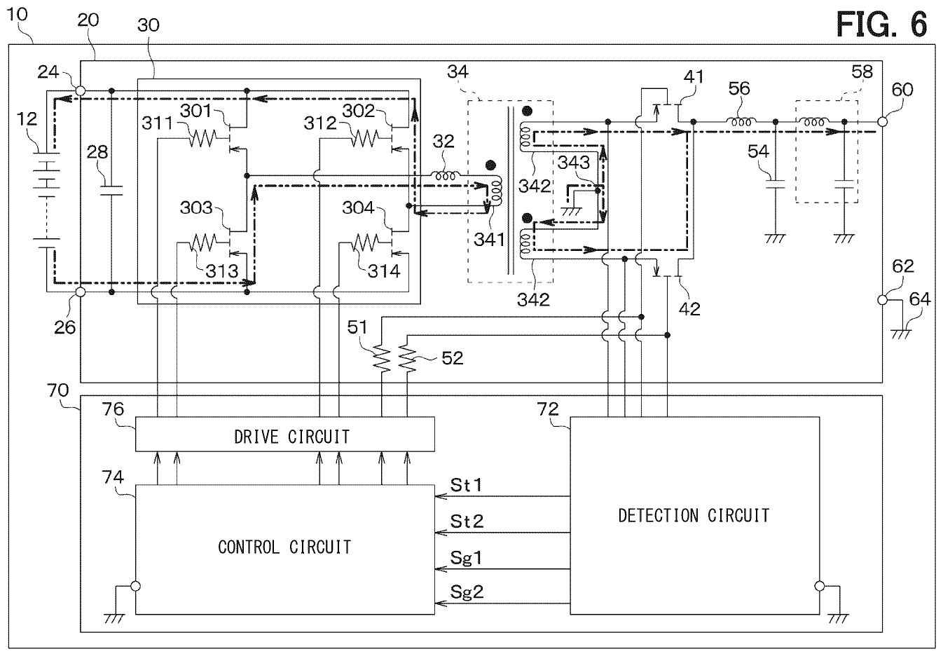

Furthermore, immediately after time t3, since the second transistor 302 and the third transistor 303 are turned on, as shown in FIG. 6, a voltage in the direction opposite to the direction in which current is flowing is applied to the magnetic component 32 and the primary winding 341. It should be noted that in FIG. 6, the flow of current is schematically shown by a two-dot chain line.

This causes the current in the primary winding 341 to decrease rapidly. Therefore, the current in the primary winding 341 becomes negative between time x3 and time x4 in the timing chart of FIG. 3.

At this time, since a continuous current flows through the choke coil 56, the current flowing through the first rectifying element 41 decreases. The current flowing through the second rectifying element 42 increases. Since a current flows through both the first rectifying element 41 and the second rectifying element 42, the first transformer voltage Vt1 and the second transformer voltage Vt2 become zero.

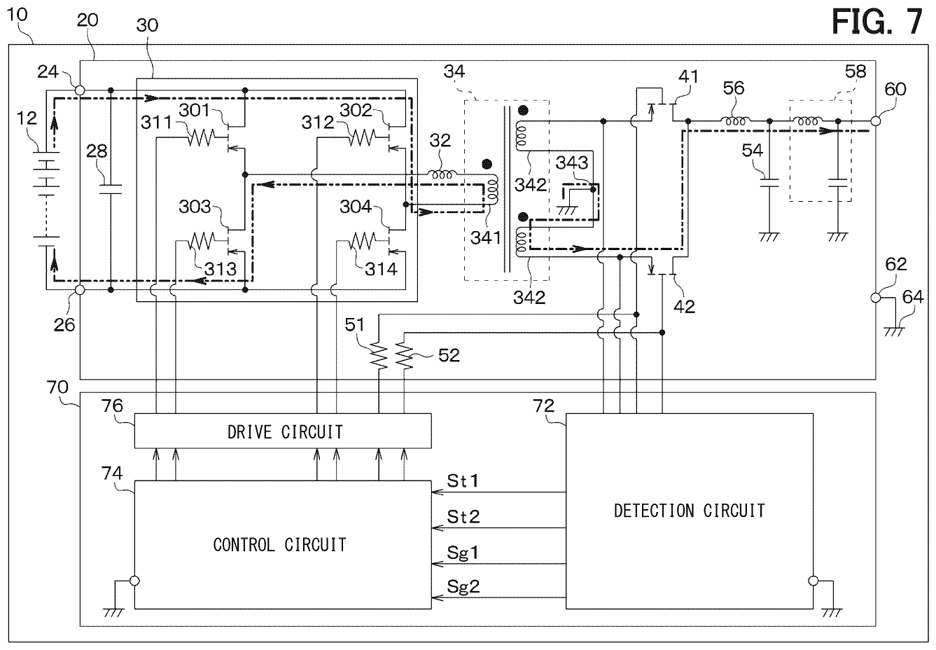

At time x4, when the current flowing through the first rectifying element 41 becomes zero, the first transformer voltage Vt1 becomes a negative value. Moreover, the second transformer voltage Vt2 becomes a positive value. At this time, as shown in FIG. 7, a current flows from the positive electrode of the DC power supply 12 through the second transistor 302, the primary winding 341, the magnetic component 32 and the third transistor 303 to the negative electrode of the DC power supply 12. In FIG. 7, the current flow is indicated typically by a two-dot chain line.

Since a current flows through the primary winding 341, the current flows through the secondary winding 342 with the stepped down voltage due to the turns ratio of the primary winding 341 to the secondary winding 342, and the electromagnetic induction. Therefore, the DC voltage from the DC power supply 12 is converted into an AC voltage by the conversion circuit 30 including the first transistor 301, the second transistor 302, the third transistor 303 and the fourth transistor 304. Moreover, the direction of the current flowing through the secondary winding 342 at this time is opposite to the direction of the current flowing through the secondary winding 342 when the first transistor 301 and the fourth transistor 304 are on. Therefore, the current of the secondary winding 342 flows through the second rectifying element 42.

Therefore, in the period from time x4 to time x5 in the timing chart of FIG. 3, the current flowing through the second rectifying element 42 increases. Furthermore, no current flows through the first rectifying element 41.

Furthermore, the current rectified by the first rectifying element 41 and the second rectifying element 42 is smoothed by the output capacitor 54 and the choke coil 56. Noise contained in the current smoothed by the output capacitor 54 and the choke coil 56 is removed by the filter 58. The voltage of the current that has passed through the filter 58 is output to the outside of the power converter 10 via the output terminal 60.

At time x5, the control circuit 74 outputs a signal to the drive circuit 76 to turn off the second transistor 302. The drive circuit 76 stops applying a voltage to the gate electrode of the second transistor 302. This causes the second transistor 302 to turn off. In addition, the control circuit 74 outputs a signal to the drive circuit 76 to turn on the fourth transistor 304. The drive circuit 76 applies a voltage to the gate electrode of the fourth transistor 304 via the fourth adjusting resistor 314. As a result, the fourth transistor 304 is turned on. At this time, the first transistor 301 is off. The third transistor 303 is on. The first rectifying element 41 is off. The second rectifying element 42 is on.

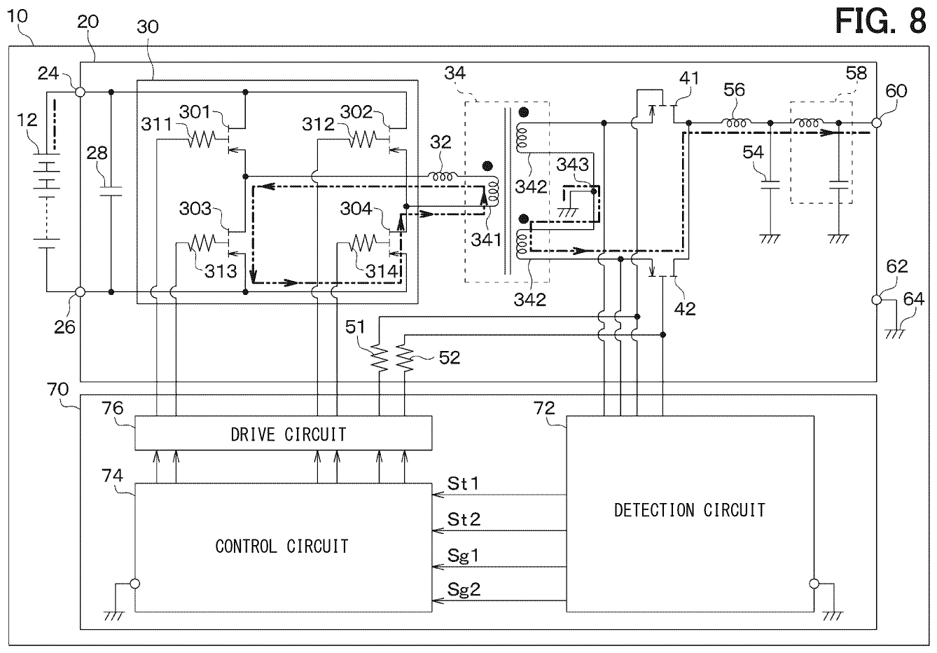

As the second transistor 302 is turned off and the fourth transistor 304 is turned on, as shown in FIG. 8, the current recirculates from the primary winding 341 through the magnetic component 32, the third transistor 303, and the fourth transistor 304, and back to the primary winding 341. The current flowing through the primary winding 341 increases during the period from time x5 to time x6 in the timing chart of FIG. 3. The absolute value of the current flowing through the primary winding 341 decreases. Therefore, the current flowing through the secondary winding 342 and the second rectifying element 42 decreases. Additionally, the first transformer voltage Vt1 and the second transformer voltage Vt2 become zero.

At time x6, the control circuit 74 outputs a signal to the drive circuit 76 to turn off the third transistor 303. The drive circuit 76 stops applying a voltage to the gate electrode of the third transistor 303. This causes the third transistor 303 to turn off. In addition, the control circuit 74 outputs a signal to the drive circuit 76 to turn on the first transistor 301. The drive circuit 76 applies a voltage to the gate electrode of the first transistor 301 via the first adjusting resistor 311. As a result, the first transistor 301 is turned on. At this time, the second transistor 302 is turned off. The fourth transistor 304 is on.

In addition, the control circuit 74 outputs a signal to the drive circuit 76 to turn off the second rectifying element 42. The drive circuit 76 stops applying a voltage to the gate electrode of the second rectifying element 42. As a result, the second rectifying element 42 is turned off.

Furthermore, the control circuit 74 outputs a signal to the drive circuit 76 to turn on the first rectifying element 41. The drive circuit 76 applies a voltage to the gate electrode of the first rectifying element 41 via the first element adjusting resistor 51. As a result, the first rectifying element 41 is turned on.

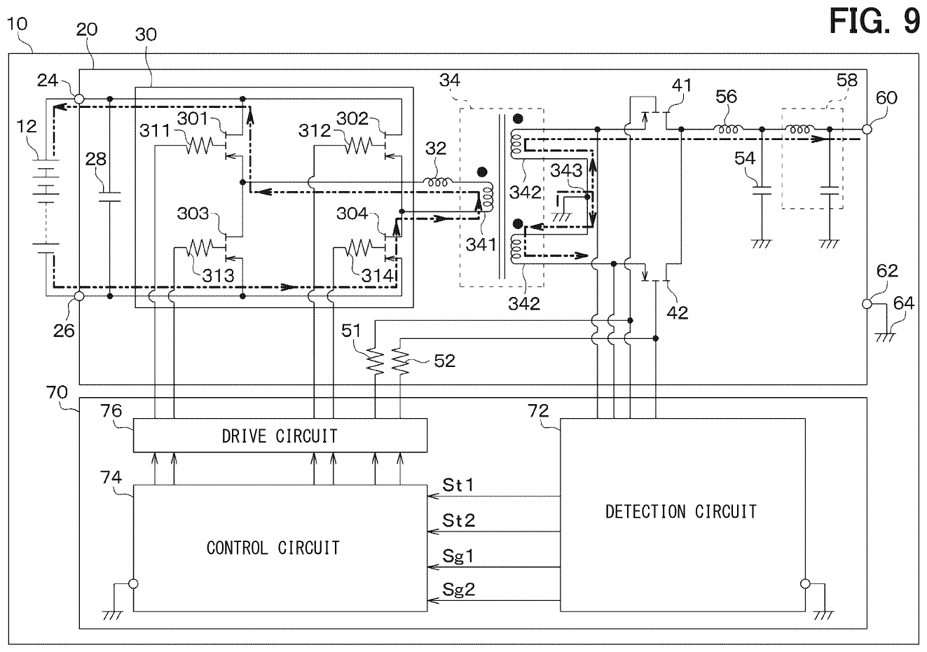

Also, immediately after time x6, since the first transistor 301 and the fourth transistor 304 are on, a voltage in the opposite direction to the direction in which the current is flowing is applied to the magnetic component 32 and the primary winding 341, as shown in FIG. 9. In FIG. 9, the flow of current is schematically shown by a two-dot chain line.

This causes the current in the primary winding 341 to increase rapidly. Therefore, the current in the primary winding 341 becomes a positive value between time x6 and time x7 in the timing chart of FIG. 3.

At this time, since a continuous current flows through the choke coil 56, the current flowing through the second rectifying element 42 decreases. The current flowing through the first rectifying element 41 increases. Since a current flows through both the first rectifying element 41 and the second rectifying element 42, the first transformer voltage Vt1 and the second transformer voltage Vt2 become zero.

At time x7, when the current flowing through the second rectifying element 42 becomes zero, the first transformer voltage Vt1 becomes a positive value. The second transformer voltage Vt2 becomes a negative value. At this time, as shown in FIG. 4, current flows from the positive terminal of the DC power supply 12 through the first transistor 301, magnetic component 32, primary winding 341, and fourth transistor 304, to the negative terminal of the DC power supply 12. Therefore, from time x7 onwards, the processes and states from time x1 to time x6 are repeated.

As described above, the power converter 10 operates as a DC-DC converter for a vehicle. Here, assume that the first rectifying element 41 is turned on during the period from time x4 when the second transformer voltage Vt2 increases from zero to time x5 when the second transistor 302 is turned off and the current flowing through the second rectifying element 42 begins to decrease. In this case, a short circuit occurs between the secondary winding 342, the first rectifying element 41, and the second rectifying element 42. As shown in the timing chart of FIG. 3, the period from time x4 to time x5 is the on-prohibition period T_on_ban for the first rectifying element 41. It is necessary to keep the first rectifying element 41 off during the period from time x4 to time x5. Thus, to ensure that the first rectifying element 41 is not on during the period from time x4 to time x5, the first rectifying element 41 should be turned off at a time x3, which is prior to time x4.

The current flows through the first rectifying element 41 during the period from time x3 to time x4. However, in the period from time x3 to time x4, the first rectifying element 41 is turned off, and therefore synchronous rectification by the first rectifying element 41 is not performed. Since synchronous rectification by the first rectifying element 41 is not performed, the voltage corresponding to the current flowing through the first rectifying element 41 during the period from time x3 to time x4 becomes larger than when the first rectifying element 41 is on. Therefore, the period from time x3 to time x4 is the power-loss period Ts for the first rectifying element 41. By shortening this power-loss period Ts, the power loss caused by the first rectifying element 41 and the second rectifying element 42 is suppressed.

A comparative DC-DC converter predicts a secondary-side current from a primary-side current, and controls the off-timing according to the predicted current or the like. However, the primary side includes a magnetic component 32 such as a coil and a transformer 34. Furthermore, the magnetic component 32 and the transformer 34 have manufacturing variations and therefore have variations in their characteristics such as reactance. As a result, the primary-side current may vary between different DC-DC converters. Therefore, the accuracy of predicting the secondary-side current may decrease. Consequently, the off-timing corresponding to the predicted current and other parameters may vary. Therefore, in the DC-DC converter described above, the variation in power loss due to the rectifying switching element may become significant. For this reason, in the DC-DC converter described above, the power loss due to the rectifying switching element may increase.

In contrast, the power converter 10 of the present embodiment suppresses the power loss caused by the first rectifying element 41 and the second rectifying element 42. For this purpose, the control circuit 74 executes the program of the control circuit 74 to turn off the first rectifying element 41 that is in the on-state based on the second transformer voltage Vt2 and the first gate voltage Vgs1. Furthermore, the control circuit 74 executes the program of the control circuit 74 to turn off the second rectifying element 42 that is in the on-state based on the first transformer voltage Vt1 and the second gate voltage Vgs2.

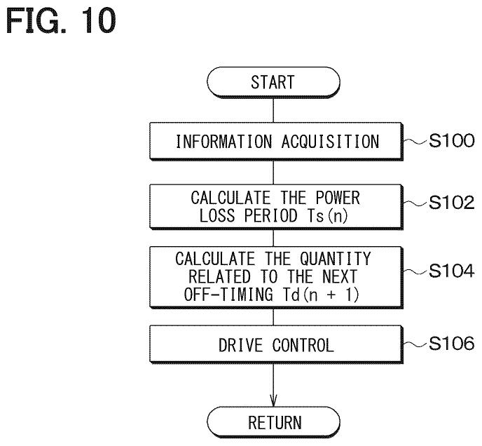

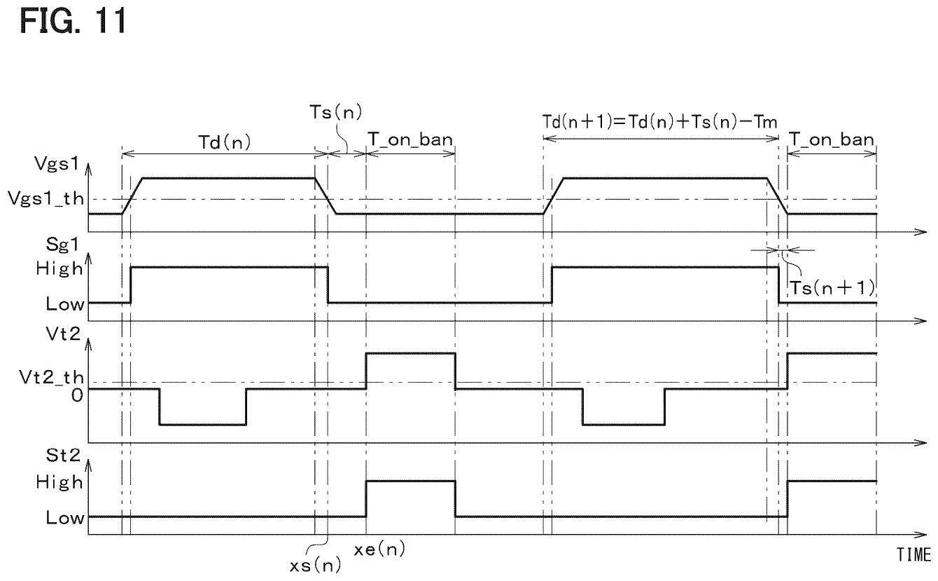

Next, the turning off of the first rectifying element 41 based on the second transformer voltage Vt2 and the first gate voltage Vgs1 through the execution of the program of the control circuit 74 will be explained with reference to the flowchart in FIG. 10 and the timing chart in FIG. 11. The program of the control circuit 74 is executed, for example, when the power supply of the power converter 10 is turned on. Furthermore, in the program of the control circuit 74, the period of a series of operations from when the control circuit 74 starts the processing of S100 to when the control circuit 74 returns to the processing of S100 is defined as the control cycle of the control circuit 74.

In S100 of the flowchart in FIG. 10, the control circuit 74 acquires various information. Specifically, the control circuit 74 acquires the second transformer detection signal St2 during a predetermined period as signal data from the second transformer voltage comparator 732 of the detection circuit 72. Furthermore, the control circuit 74 obtains the first gate detection signal Sg1 during a predetermined period from the first gate voltage comparator 751 of the detection circuit 72 as signal data.

As described above, the second transformer detection signal St2 is a signal according to the result of comparison between the second transformer voltage Vt2 and the second transformer voltage threshold Vt2_th. The second transformer voltage Vt2 is the voltage between the transformer 34 and the second rectifying element 42. The first gate detection signal Sg1 is a signal according to the result of comparison between the first gate voltage Vgs1 and the first gate voltage threshold Vgs1_th. The first gate voltage Vgs1 is the voltage of the gate electrode of the first rectifying element 41. Furthermore, the power-loss period Ts for the first rectifying element 41 is the period from when the first rectifying element 41 is turned off to when the second transformer voltage Vt2 increases from zero. The on/off of the first rectifying element 41 corresponds to a change in the first gate voltage Vgs1, and therefore corresponds to a change in the voltage level of the first gate detection signal Sg1. The change in the second transformer voltage Vt2 corresponds to the change in the voltage level of the second transformer detection signal St2.

Therefore, the power-loss period Ts for the first rectifying element 41 can be calculated from the changes in the voltage levels of the first gate detection signal Sg1 and the second transformer detection signal St2.

Thus, in S102 following S100, the control circuit 74 calculates the power-loss period Ts(n) for the first rectifying element 41 in the present control cycle based on the change in the voltage level of the signal obtained in S100.

Specifically, as shown in the timing chart of FIG. 11, the control circuit 74 calculates the time xs(n) when the voltage level of the first gate detection signal Sg1 transitions from high level to low level. Additionally, the control circuit 74 calculates the time xe(n) when the voltage level of the second transformer detection signal St2 transitions from low level to high level. In the timing chart, the period when the voltage level is high is indicated as High. The period when the voltage level is low is indicated as Low.

Here, the time xs(n) is when the first gate voltage Vgs1 drops from a value larger than or equal to the first gate voltage threshold Vgs1_th to a value smaller than the first gate voltage threshold Vgs1_th. The time xs(n) corresponds to the timing when the first rectifying element 41, which is in the on-state, is turned off. Therefore, the first gate voltage threshold Vgs1_th is set through experiments or simulations so that the on/off state of the first rectifying element 41 can be determined.

Furthermore, time xe(n) is the time when the second transformer voltage Vt2 changes from a value smaller than the second transformer voltage threshold Vt2_th to a value equal to or larger than the second transformer voltage threshold Vt2_th. The time xe(n) corresponds to the time when the second transformer voltage Vt2 increases from zero. The value smaller than the second transformer voltage threshold Vt2_th is set by experiment, simulation, or the like so as to determine whether or not the second transformer voltage Vt2 is increasing from zero.

The control circuit 74 calculates the period from the calculated time xs(n) to the time xe(n). In this way, the control circuit 74 calculates the power-loss period Ts(n) for the first rectifying element 41 in the present control cycle.

In S104 following S102, the control circuit 74 calculates a quantity Td(n+1) related to the off-timing of the first rectifying element 41 in the next control cycle from the power-loss period Ts(n) calculated in S102 and the following equation (1).

$$Td ( n + 1 ) = Td ( n ) + Ts ( n ) - Tm \qquad ( 1 )$$

Td(n) in the above equation (1) is the quantity Td related to the timing at which the first rectifying element 41 in the on-state is turned off in the present control cycle, and is calculated in the previous control cycle. Therefore, Td(1) is the quantity Td related to the timing of turning off the first rectifying element 41 that is in the on-state during the initial control cycle. Td(1) is the time from when, for example, the control circuit 74 outputs a signal to turn the first transistor 301 from off to on, to when the control circuit 74 outputs a signal to turn the first transistor 301 from on to off, such that Td(2) can be calculated. Also, the starting point for the quantity Td related to the off-timing of the first rectifying element 41 is set here as the moment when the control circuit 74 outputs a signal to turn the first transistor 301 from off to on. On the other hand, the starting point for the quantity Td related to the off-timing of the first rectifying element 41 may be set as the moment when the control circuit 74 outputs a signal to turn the fourth transistor 304 from off to on. Alternatively, the starting point for the quantity Td related to the off-timing of the first rectifying element 41 may be set as the moment when the control circuit 74 outputs a signal to turn the first rectifying element 41 from off to on. Alternatively, the starting point for the quantity Td related to the off-timing of the first rectifying element 41 may be at a predetermined time when the first transistor 301, the fourth transistor 304, and the first rectifying element 41 are all in the on-state.

Furthermore, Tm in the above equation (1) is the adjustment quantity for the quantity Td related to the off-timing of the first rectifying element 41. Tm is set through experiments, simulations, or the like so that the off-timing of the first rectifying element 41 does not enter the on prohibition period T_on_ban.

In S106 following S104, the control circuit 74 outputs a signal to the drive circuit 76 for turning on and off the second transistor 302, the third transistor 303, and the second rectifying element 42. As a result, current rectified by the second rectifying element 42 flows. Thereafter, the control circuit 74 turns off the second transistor 302, the third transistor 303, and the second rectifying element 42. Then, the control circuit 74 outputs a signal to the drive circuit 76 to turn on the first transistor 301, the fourth transistor 304, and the first rectifying element 41. As a result, as described above, current rectified by the first rectifying element 41 flows. After that, the control circuit 74 turns off the first transistor 301 and the fourth transistor 304.

Then, the control circuit 74 outputs a signal to turn off the first rectifying element 41 based on the quantity Td(n+1) related to the off-timing of the first rectifying element 41, calculated in S104. Since the quantity Td related to the off-timing of the first rectifying element 41 includes the power-loss period Ts, the power-loss period Ts becomes shorter, and the first rectifying element 41 is turned off. As a result, the power loss caused by the first rectifying element 41 is reduced. Thereafter, the processing of the control circuit 74 returns to S100.

As described above, the control circuit 74 turns off the first rectifying element 41 that is in the on-state, based on the second transformer voltage Vt2 and the first gate voltage Vgs1. The following explains the turn-off operation of the second rectifying element 42 based on the first transformer voltage Vt1 and the second gate voltage Vgs2, executed by the program of the control circuit 74.

The turn-off operation of the second rectifying element 42, based on the first transformer voltage Vt1 and the second gate voltage Vgs2, is performed in the same manner as the turn-off operation of the first rectifying element 41, which is based on the second transformer voltage Vt2 and the first gate voltage Vgs1. Specifically, in the processing from S100 and back to S100, the first transistor 301 is replaced with the third transistor 303. The fourth transistor 304 is replaced with the second transistor 302. The first rectifying element 41 is replaced with the second rectifying element 42. The second rectifying element 42 is replaced with the first rectifying element 41. The second transformer voltage Vt2 is replaced with the first transformer voltage Vt1. The second transformer voltage threshold Vt2_th is replaced with the first transformer voltage threshold Vt1_th. The first gate voltage Vgs1 is replaced with the second gate voltage Vgs2. The first gate voltage threshold Vgs1_th is replaced with the second gate voltage threshold Vgs2_th. The second transformer detection signal St2 is replaced with the first transformer detection signal St1. The second transformer voltage comparator 732 is replaced with the first transformer voltage comparator 731. The first gate detection signal Sg1 is replaced with the second gate detection signal Sg2. The first gate voltage comparator 751 is replaced with the second gate voltage comparator 752.

Next, in the power converter 10 according to the present embodiment, the reduction of power loss caused by the first rectifying element 41 and the second rectifying element 42 will be explained.

The power converter 10 includes the conversion circuit 30, the magnetic component 32, the transformer 34, the first rectifying element 41, the second rectifying element 42, the detection circuit 72, and the control circuit 74. The conversion circuit 30 converts the DC voltage from the DC power supply 12 into the AC voltage. The AC voltage converted by the conversion circuit 30 is applied to the magnetic component 32. The transformer 34 steps down the AC voltage applied via the magnetic component 32. The first rectifying element 41 and the second rectifying element 42 are transistors, and rectify the current of the AC voltage stepped down by the transformer 34. Moreover, the first rectifying element 41 performs synchronous rectification by being turned on during a period in which a current flows through the first rectifying element 41. As a result, the first rectifying element 41 suppresses the power loss occurring in the first rectifying element 41. Furthermore, the second rectifying element 42 performs synchronous rectification by turning on during the period when current is flowing through the second rectifying element 42. As a result, the second rectifying element 42 suppresses the power loss that occurs in the second rectifying element 42. The detection circuit 72 detects the first transformer voltage Vt1 and the second transformer voltage Vt2. The control circuit 74 turns off the first rectifying element 41 that is in the on-state based on the second transformer voltage Vt2. Furthermore, the control circuit 74 turns off the second rectifying element 42 that is in the on-state based on the first transformer voltage Vt1.

Thus, the first rectifying element 41 and the second rectifying element 42 in the on-state are turned off without using the current flowing through the primary side corresponding to between the conversion circuit 30 and the transformer 34. Therefore, the influence of variations in the current flowing through the primary side is suppressed, allowing the first rectifying element 41 and the second rectifying element 42 in the on-state to turn off. Therefore, the variation in the off-timing of the first rectifying element 41 and the second rectifying element 42 in the on-state is suppressed. In addition, by using the second transformer voltage Vt2, the first rectifying element 41 is not turned on during the on-prohibited period T_on_ban for the first rectifying element 41, and the power-loss period Ts for the first rectifying element 41 can be shortened, thereby turning off the first rectifying element 41. Furthermore, by using the first transformer voltage Vt1, the second rectifying element 42 is not turned on during the on-prohibited period T_on_ban for the second rectifying element 42, and the power-loss period Ts for the second rectifying element 42 can be shortened, thereby turning off the second rectifying element 42. Therefore, the power-loss period Ts can be shortened while suppressing variation in the off-timing of the first rectifying element 41 and the second rectifying element 42 that are in the on-state. Therefore, the power loss due to the first rectifying element 41 and the second rectifying element 42 is suppressed.

The power converter 10 according to the present embodiment also achieves the following effects.

Each of the first rectifying element 41 and the second rectifying element 42 includes a transistor. The detection circuit 72 detects a first gate voltage Vgs1 and a second gate voltage Vgs2 in addition to the first transformer voltage Vt1 and the second transformer voltage Vt2.

The control circuit 74 calculates the quantity Td relating to the off-timing of the first rectifying element 41 based on the first gate voltage Vgs1 and the second transformer voltage Vt2. Specifically, the control circuit 74 calculates the current power-loss period Ts(n) for the first rectifying element 41 using the first gate voltage Vgs1 and the second transformer voltage Vt2. Furthermore, the control circuit 74 uses the current power-loss period Ts(n) for the first rectifying element 41 and the present off-timing related quantity Td(n) for the first rectifying element 41. This allows the control circuit 74 to calculate the off-timing related quantity Td(n+1) for the first rectifying element 41 for the next time. Furthermore, the control circuit 74 turns off the first rectifying element 41 in the on-state for the next time based on the calculated off-timing related quantity Td(n+1) for the first rectifying element 41. It should be noted that while the current off-timing related quantity Td(n) is used here, an off-timing related quantity Td from a time prior to the present moment may also be used.

By using the first gate voltage Vgs1 and the second transformer voltage Vt2, it becomes easier to calculate the off-timing related quantity Td for the first rectifying element 41. This suppresses a decrease in the accuracy of calculating the quantity Td relating to the off-timing of the first rectifying element 41. This reduces variation in the off-timing of the first rectifying element 41 in the on-state. Therefore, the power loss caused by the first rectifying element 41 is suppressed.

Furthermore, the control circuit 74 calculates the off-timing related quantity Td for the second rectifying element 42 based on the second gate voltage Vgs2 and the first transformer voltage Vt1. Specifically, the control circuit 74 uses the second gate voltage Vgs2 and the first transformer voltage Vt1 to calculate the power-loss period Ts(n) for the second rectifying element 42 at the present time. Furthermore, the control circuit 74 uses the power-loss period Ts(n) for the second rectifying element 42 at the present time and the off-timing related quantity Td(n) for the second rectifying element 42 at the present time. As a result, the control circuit 74 calculates the off-timing related quantity Td(n+1) for the second rectifying element 42 for the next time. Additionally, the control circuit 74 turns off the second rectifying element 42 in the next time based on the calculated off-timing related quantity Td(n+1) for the second rectifying element 42.

By using the second gate voltage Vgs2 and the first transformer voltage Vt1, it becomes easier to calculate the off-timing related quantity Td for the second rectifying element 42. Therefore, similarly to the above, the power loss due to the second rectifying element 42 is suppressed.

### Second Embodiment

In a second embodiment, the processing of the control circuit 74 when the first rectifying element 41 is turned off based on the second transformer voltage Vt2 and the first gate voltage Vgs1 is different from that in the first embodiment. In addition, the processing of the control circuit 74 when the second rectifying element 42 is turned off based on the first transformer voltage Vt1 and the second gate voltage Vgs2 differs from that in the first embodiment. The other configurations are similar to those of the first embodiment. The following describes the processing of the control circuit 74 for turning off the first rectifying element 41 based on the second transformer voltage Vt2 and the first gate voltage Vgs1.

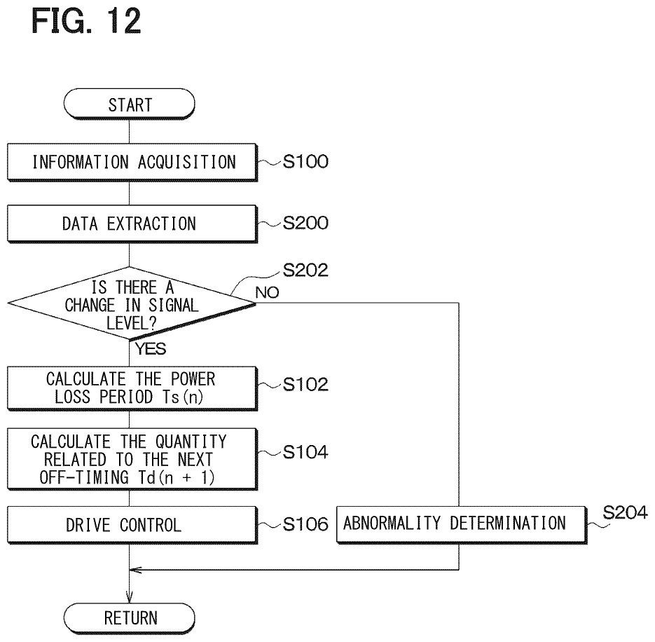

As shown in the flowchart of FIG. 12, in S100, the control circuit 74 acquires the second transformer detection signal St2 for a predetermined period as signal data from the second transformer voltage comparator 732 of the detection circuit 72, similarly to the first embodiment. Furthermore, the control circuit 74 acquires the first gate detection signal Sg1 for a predetermined period as signal data from the first gate voltage comparator 751 of the detection circuit 72.

As described above, the power-loss period Ts for the first rectifying element 41 is calculated based on the changes in the voltage levels of the second transformer detection signal St2 and the first gate detection signal Sg1. In contrast, due to noise or the like, the voltage levels of the second transformer detection signal St2 and the first gate detection signal Sg1 may change in a period that does not correspond to the power-loss period Ts. At this time, the change in the voltage level of the second transformer detection signal St2 and the first gate detection signal Sg1 is erroneously detected, so that the power-loss period Ts calculated by the control circuit 74 becomes an incorrect period. If the power-loss period Ts calculated by the control circuit 74 is an incorrect period, the timing of turning off the first rectifying element 41 will be incorrect.

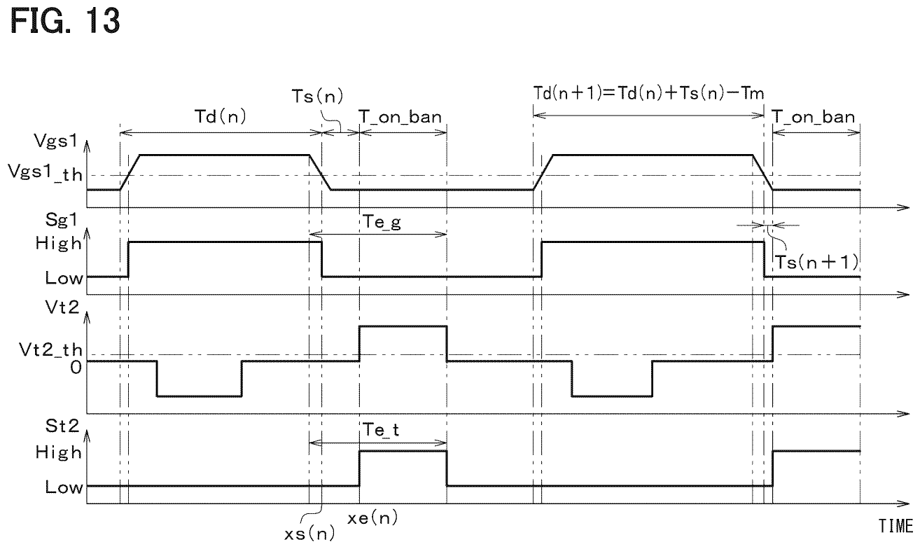

Therefore, in S200 following S100, the control circuit 74 extracts the second transformer detection signal St2 suitable for calculating the power-loss period Ts from the signal data acquired in S100. Specifically, as shown in the timing chart of FIG. 13, the control circuit 74 extracts the second transformer detection signal St2 for the period from when a signal that changes the first transistor 301 from on to off is output to when a signal that changes the fourth transistor 304 from off to on is output. In the timing chart of FIG. 13, the period from when a signal that changes the first transistor 301 from on to off is output to when a signal that changes the fourth transistor 304 from off to on is output is indicated as Te_t.

Furthermore, the control circuit 74 extracts the first gate detection signal Sg1 suitable for calculating the power-loss period Ts from the signal data acquired in S100. Specifically, the control circuit 74 extracts the first gate detection signal Sg1 during the period from when the signal to turn off the first rectifying element 41 is output to when the signal to turn on the fourth transistor 304 is output. In the timing chart of FIG. 13, the period from the time a signal to turn off the first rectifying element 41 is output to the time a signal to turn on the fourth transistor 304 is output is indicated as Te_g.

With regard to the flowchart of FIG. 12, in S202 following S200, the control circuit 74 determines whether or not there is a change in the voltage levels of the second transformer detection signal St2 and the first gate detection signal Sg1 extracted in S200. This allows the control circuit 74 to determine whether the power converter 10 is normal or not.

Specifically, the control circuit 74 determines whether the voltage level of the second transformer detection signal St2 extracted in S200 has changed from a low level to a high level. Furthermore, the control circuit 74 determines whether the voltage level of the first gate detection signal Sg1 extracted in S200 has changed from high level to low level.

Then, if the voltage level of the second transformer detection signal St2 has not changed from low level to high level, it indicates that the power converter 10 is not operating normally. Consequently, the processing of the control circuit 74 proceeds to S204. Furthermore, if the voltage level of the first gate detection signal Sg1 has not changed from high level to low level, it indicates that the power converter 10 is not operating normally. Consequently, the processing of the control circuit 74 proceeds to S204. Additionally, when the voltage level of the second transformer detection signal St2 changes from low level to high level, and the voltage level of the first gate detection signal Sg1 changes from high level to low level, it indicates that the power converter 10 is operating normally. Therefore, at this time, the processing of the control circuit 74 proceeds to S102. In S102, the control circuit 74 calculates the power-loss period Ts(n) for the first rectifying element 41 during the present control cycle based on the changes in the voltage levels of the first transformer detection signal St1 and the first gate detection signal S_g1 extracted in S200. After the processing of S102, the control circuit 74 performs the processing of S104 and S106 in the same manner as in the first embodiment.

In S204, which follows S202, there should be a change in the voltage levels of the second transformer detection signal St2 and the first gate detection signal Sg1. However, there is no change in the voltage levels of either the second transformer detection signal St2 or the first gate detection signal Sg1. At this time, therefore, the control circuit 74 determines that the power converter 10 is abnormal. Furthermore, the control circuit 74 stops the output of signals that turn on and off the first transistor 301, the second transistor 302, the third transistor 303, the fourth transistor 304, the first rectifying element 41, and the second rectifying element 42. The control circuit 74 also outputs an alarm using, for example, text display, sound, and light. Thereafter, the processing of the control circuit 74 returns to S100.

As described above, the control circuit 74 of the power converter 10 in the second embodiment turns off the first rectifying element 41 that is in the on-state based on the first transformer voltage Vt1 and the first gate voltage Vgs1. It should be noted that the processing of the control circuit 74 for turning off the second rectifying element 42 is carried out in the same manner as the processing of the control circuit 74 for turning off the first rectifying element 41. Specifically, in the processing from S100 and back to S100, the first transistor 301 is replaced with the third transistor 303. The fourth transistor 304 is replaced with the second transistor 302. The first rectifying element 41 is replaced with the second rectifying element 42. The second rectifying element 42 is replaced with the first rectifying element 41. The second transformer voltage Vt2 is replaced with the first transformer voltage Vt1. The first gate voltage Vgs1 is replaced with the second gate voltage Vgs2. The second transformer detection signal St2 is replaced with the first transformer detection signal St1. The second transformer voltage comparator 732 is replaced with the first transformer voltage comparator 731. The first gate detection signal Sg1 is replaced with the second gate detection signal Sg2. The first gate voltage comparator 751 is replaced with the second gate voltage comparator 752.

The second embodiment achieves effects similar to the effects achieved by the first embodiment. The second embodiment also achieves the following effects.

The control circuit 74 calculates the power-loss period Ts for the first rectifying element 41 using the first gate voltage Vgs1 for a period based on the change in voltage level of the signal that drives the conversion circuit 30 and the change in voltage level of the signal that turns the first rectifying element 41 on and off. It should be noted that the above-mentioned period corresponds to the period from when the control circuit 74 outputs a signal to change the first rectifying element 41 from on to off to when the control circuit 74 outputs a signal to change the fourth transistor 304 from off to on.

This suppresses erroneous detection of a change in the voltage level of the first gate detection signal Sg1. Therefore, miscalculation of the power-loss period Ts for the first rectifying element 41 is suppressed. Therefore, the first rectifying element 41 is prevented from being turned off at an incorrect timing.

Furthermore, the control circuit 74 calculates the power-loss period Ts for the second rectifying element 42 using the second gate voltage Vgs2 during the period based on the changes in the voltage levels of the signals driving the conversion circuit 30 and the changes in the signals that turn on and off the second rectifying element 42. It should be noted that the above period corresponds to the period from when the control circuit 74 outputs a signal to turn off the second rectifying element 42 to when the control circuit 74 outputs a signal to turn on the second transistor 302.

This suppresses erroneous detection of a change in the voltage level of the second gate detection signal Sg2. This prevents miscalculation of the power-loss period Ts for the second rectifying element 42. This prevents the second rectifying element 42 from being turned off at an incorrect timing.

Assuming that the voltage level of the first gate detection signal Sg1 does not change from high level to low level during the period based on the changes in the signals driving the conversion circuit 30 and the changes in the signals turning the first rectifying element 41 on and off. At this time, the control circuit 74 determines that the power converter 10 is abnormal. This makes it possible to determine whether or not the power converter 10 is abnormal. It should be noted that when the voltage level of the first gate detection signal Sg1 does not change from high level to low level, it corresponds to the situation where the first gate voltage Vgs1 does not drop from a value larger than or equal to the first gate voltage threshold Vgs1_th to a value smaller than the first gate voltage threshold Vgs1_th.

Furthermore, assuming that during the period based on the changes in the signals driving the conversion circuit 30 and the changes in the signals turning the second rectifying element 42 on and off, the voltage level of the second gate detection signal Sg2 does not change from high level to low level. At this time, the control circuit 74 determines that the power converter 10 is abnormal. This makes it possible to determine whether or not the power converter 10 is abnormal. It should be noted that when the voltage level of the second gate detection signal Sg2 does not change from high level to low level, it corresponds to the situation where the second gate voltage Vgs2 does not drop from being above the second gate voltage threshold Vgs2_th to below the second gate voltage threshold Vgs2_th.

The control circuit 74 calculates the power-loss period T_s for the first rectifying element 41 using the second transformer voltage Vt2 during the period based on the voltage level changes of the signal driving the conversion circuit 30. It should be noted that the period based on the voltage level changes of the signal driving the conversion circuit 30 corresponds to the period from when the signal turning the first transistor 301 from on to off is output to when the signal turning the fourth transistor 304 from off to on is output.

As a result, false detection of voltage level changes in the second transformer detection signal St2 is suppressed. Therefore, miscalculation of the power-loss period Ts for the first rectifying element 41 is suppressed. Therefore, the first rectifying element 41 is prevented from being turned off at an incorrect timing.

In addition, the control circuit 74 calculates the power-loss period Ts for the second rectifying element 42 by using the first transformer voltage Vt1 for a period based on a change in the voltage level of the signal that drives the conversion circuit 30. The period based on the change in voltage level of the signal that drives the conversion circuit 30 corresponds to the period from when a signal that changes the third transistor 303 from on to off is output to when a signal that changes the second transistor 302 from off to on is output.

This suppresses erroneous detection of a change in the voltage level of the first transformer detection signal St1. This prevents miscalculation of the power-loss period Ts for the second rectifying element 42. This prevents the second rectifying element 42 from being turned off at an incorrect timing.

Assuming that during the period based on the voltage level changes of the signal driving the conversion circuit 30, the voltage level of the first transformer detection signal St1 does not change from low level to high level. At this time, the control circuit 74 determines that the power converter 10 is abnormal. This makes it possible to determine whether or not the power converter 10 is abnormal. It should be noted that when the voltage level of the first transformer detection signal St1 does not change from low level to high level, it corresponds to the situation where the first transformer voltage Vt1 does not rise from a value smaller than the first transformer voltage threshold Vt1_th to a value larger than or equal to the first transformer voltage threshold Vt1_th.

Assuming that during the period based on the voltage level changes of the signal driving the conversion circuit 30, the voltage level of the second transformer detection signal St2 does not change from low level to high level. At this time, the control circuit 74 determines that the power converter 10 is abnormal. This makes it possible to determine whether or not the power converter 10 is abnormal. It should be noted that when the voltage level of the second transformer detection signal St2 does not change from low level to high level, it corresponds to the situation where the second transformer voltage Vt2 does not rise from a value smaller than the second transformer voltage threshold Vt2_th to a value larger than or equal to the second transformer voltage threshold Vt2_th.

### Third Embodiment

In a third embodiment, the calculation of the power-loss period Ts in S102 is different from that in the second embodiment. The other configurations are the same as those of the second embodiment.

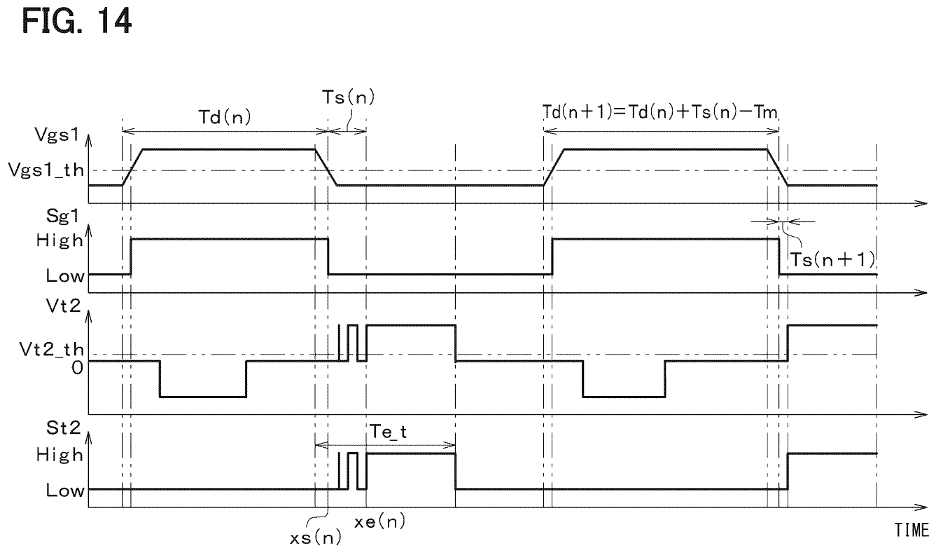

As shown in the timing chart of FIG. 14, it is assumed that this is the period from when a signal that changes the first transistor 301 from on to off is output to when a signal that changes the fourth transistor 304 from off to on is output. At this time, due to noise, the second transformer voltage Vt2 may fluctuate from a value smaller than the second transformer voltage threshold Vt2_th to a value larger than or equal to the second transformer voltage threshold Vt2_th. As a result, during this period, the voltage level of the second transformer detection signal St2 may change from a low level to a high level several times.

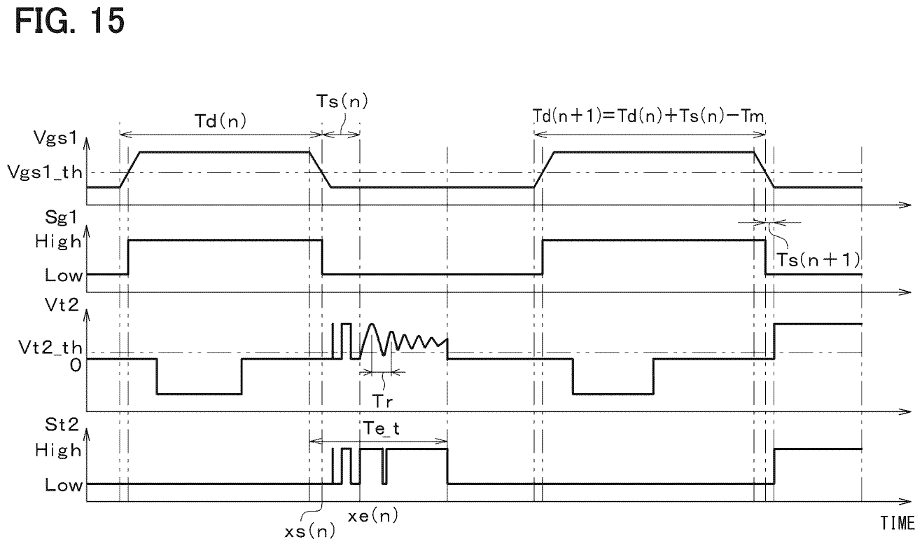

Furthermore, here, as shown in the timing chart of FIG. 15, let it be the period from the time when the signal to turn off the first transistor 301 is output to the time when the signal to turn on the fourth transistor 304 is output. At this time, due to resonance, the second transformer voltage Vt2 may fluctuate from a value smaller than the second transformer voltage threshold Vt2_th to a value larger than or equal to the second transformer voltage threshold Vt2_th. As a result, during this period, the voltage level of the second transformer detection signal St2 may change from a low level to a high level several times.

If there are multiple instances where the voltage level of the second transformer detection signal St2 changes from low level to high level, the changes in the voltage level of the second transformer detection signal St2 may be falsely detected, resulting in an incorrect power-loss period Ts being calculated by the control circuit 74. If the power-loss period Ts calculated by the control circuit 74 is an incorrect period, the timing of turning off the first rectifying element 41 will be incorrect.

In response to these issues, in the third embodiment, at S102, the control circuit 74 designates the time at which the voltage level of the second transformer detection signal St2 changes from low level to high level, with the longest duration among the following times, as the time xe(n) for the first rectifying element 41. Furthermore, as shown in the timing chart of FIG. 14, the control circuit 74 calculates the power-loss period Ts for the first rectifying element 41 using the time xe(n) for the first rectifying element 41. The aforementioned time refers to the duration from when the voltage level of the second transformer detection signal St2 changes from low level to high level until the voltage level of the second transformer detection signal St2 changes from high level to low level.

In S102, the control circuit 74 selects a time when the above-mentioned time is longer than the resonance period Tr, as shown in the timing chart of FIG. 15. The control circuit 74 sets the earliest time among the selected times as the time xe(n) for the first rectifying element 41. The control circuit 74 calculates the power-loss period Ts for the first rectifying element 41 using the time xe(n) for the first rectifying element 41. The resonance period Tr is determined based on the resonance frequency, which is derived from the inductance of the magnetic component 32 and the transformer 34, as well as the capacitance of the first rectifying element 41 and the second rectifying element 42.

Furthermore, the control circuit 74 designates the time at which the voltage level of the first transformer detection signal St1 changes from low level to high level as the time xe(n) for the second rectifying element 42, with this time being the longest among the following times. The control circuit 74 calculates the power-loss period Ts for the second rectifying element 42 using the time xe(n) for the second rectifying element 42. The above-mentioned time is the time from when the voltage level of the first transformer detection signal St1 changes from a low level to a high level until when the voltage level of the first transformer detection signal St1 changes from a high level to a low level.

Alternatively, the control circuit 74 selects a time when the time is longer than the resonance period Tr. The control circuit 74 sets the earliest time among the selected times as the time xe(n) for the second rectifying element 42. The control circuit 74 calculates the power-loss period Ts for the second rectifying element 42 using the time xe(n) for the second rectifying element 42.

As described above, the control circuit 74 of the power converter 10 of the third embodiment calculates the power-loss period Ts in S102. The third embodiment achieves effects similar to the effects achieved by the second embodiment. The third embodiment also achieves the following effects.

The control circuit 74 designates the time at which the voltage level of the second transformer detection signal St2 changes from low level to high level as the time xe(n) for the first rectifying element 41, with this time being the longest among the times for the second transformer detection signal St2. Alternatively, the control circuit 74 designates the earliest time among the times for the second transformer detection signal St2 that are longer than the resonance period Tr as the time xe(n). Furthermore, the control circuit 74 calculates the power-loss period Ts for the first rectifying element 41 by using the time xe(n) for the selected first rectifying element 41.

This suppresses a decrease in the accuracy of calculating the power-loss period Ts for the first rectifying element 41. This suppresses a decrease in the accuracy of calculating the quantity Td relating to the off-timing of the first rectifying element 41. Therefore, the variation in the timing at which the first rectifying element 41 in the on-state is turned off is suppressed. Therefore, the power loss caused by the first rectifying element 41 is suppressed.

Additionally, the control circuit 74 designates the time at which the voltage level of the first transformer detection signal St1 changes from low level to high level as the time xe(n) for the second rectifying element 42, with this time being the longest among the times for the first transformer detection signal St1. Alternatively, the control circuit 74 designates the earliest time among the times for the first transformer detection signal St1 that are longer than the resonance period Tr as the time xe(n). Furthermore, the control circuit 74 calculates the power-loss period Ts for the second rectifying element 42 using the time xe(n) for the selected second rectifying element 42.

This suppresses a decrease in the accuracy of calculating the power-loss period Ts for the second rectifying element 42. This suppresses a decrease in the accuracy of calculating the quantity Td relating to the off-timing of the second rectifying element 42. Therefore, the variation in the timing at which the second rectifying element 42 is turned off in the on-state is suppressed. Therefore, the power loss caused by the second rectifying element 42 is suppressed.

### Fourth Embodiment

In the fourth embodiment, the control circuit 74 corrects the power-loss period Ts calculated in S102. The other configuration is the same as that of the first embodiment.

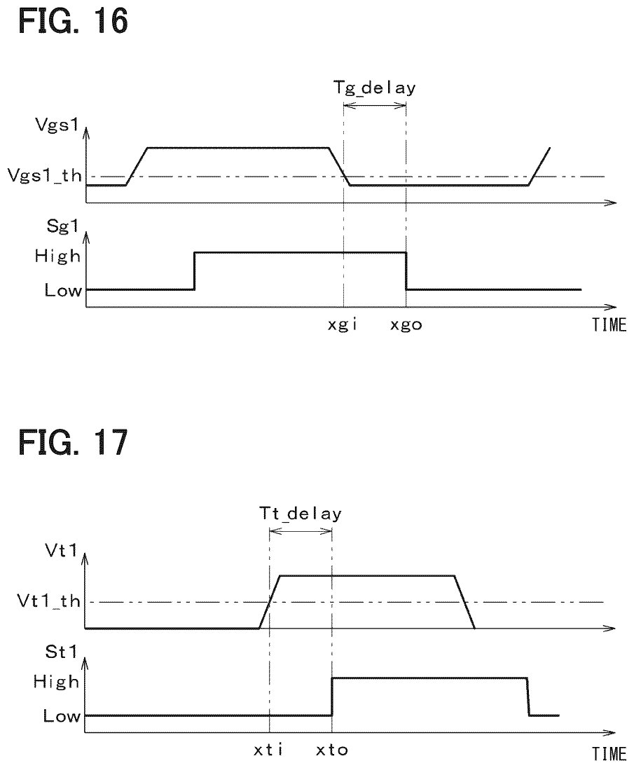

In the following, the time at which the first gate voltage Vgs1 is detected by a first gate voltage detection unit 741 is referred to as time xgi. The time at which the first gate detection signal Sg1, corresponding to the first gate voltage Vgs1 detected by the first gate voltage detection unit 741, is output from the first gate voltage comparator 751 is referred to as time xgo. As shown in the timing chart of FIG. 16, the time xgo is later than the time xgi. Therefore, there is a time difference between the time xgi and the time xgo.

In the following, the time at which the second transformer voltage Vt2 is detected by a second transformer voltage detection unit 722 is referred to as time xti. The time at which the second transformer detection signal St2, corresponding to the second transformer voltage Vt2 detected by the second transformer voltage detection unit 722, is output from the second transformer voltage comparator 732 is referred to as time xto. As shown in the timing chart of FIG. 17, the time xto is later than the time xti. Therefore, there is a time difference between time xti and time xto.

Due to these time differences, the accuracy of calculating the power-loss period Ts for the first rectifying element 41 may decrease.

In the fourth embodiment, in S102, the control circuit 74 corrects the power-loss period Ts(n) for the first rectifying element 41 based on the times xgi, xgo, xti, and xto.

In the following, the time from time xgi to time xgo in the present control cycle is referred to as Tg_delay(n). The time from time xti to time xto in the present control cycle is defined as Tt_delay(n).

For example, the control circuit 74 substitutes Tg_delay(n) and Tt_delay(n) into the following equation (2). As a result, the control circuit 74 corrects the power-loss period Ts(n) in the present control cycle. In the following equation (2), Ts_C(n) is the corrected power-loss period Ts in the present control cycle.

$$Ts\_C ( n ) = Ts ( n ) + Tg\_delay ( n ) - Tt\_delay ( n ) \qquad ( 2 )$$

The control circuit 74 uses Ts_C(n) to calculate a quantity Td(n+1) relating to the off-timing of the first rectifying element 41 in the next control cycle.

The control circuit 74 corrects the power-loss period Ts(n) for the second rectifying element 42 in the same manner as described above. Specifically, in the description of the correction of the power-loss period Ts(n) for the first rectifying element 41, the first gate voltage detection unit 741 is replaced with the second gate voltage detection unit 742. The first gate voltage Vgs1 is replaced with the second gate voltage Vgs2. The first gate detection signal Sg1 is replaced with the second gate detection signal Sg2. The first gate voltage comparator 751 is replaced with the second gate voltage comparator 752. The second transformer voltage detection unit 722 is replaced with the first transformer voltage detection unit 721. The second transformer voltage Vt2 is replaced with the first transformer voltage Vt1. The second transformer detection signal St2 is replaced with the first transformer detection signal St1. The second transformer voltage comparator 732 is replaced with the first transformer voltage comparator 731. The first rectifying element 41 is replaced with the second rectifying element 42.

As described above, the control circuit 74 of the power converter 10 according to the fourth embodiment corrects the power-loss period Ts. The fourth embodiment achieves effects similar to the effects achieved by the first embodiment. The first embodiment also achieves the following effects.

The control circuit 74 corrects the power-loss period Ts for the first rectifying element 41 based on the times xgi and xgo. At this time, the time xgi corresponds to the time at which the first gate voltage Vgs1 is detected by the detection circuit 72. The time xgo at this time corresponds to the time when the first gate detection signal Sg1 corresponding to the first gate voltage Vgs1 detected by the detection circuit 72 is output from the detection circuit 72.

The control circuit 74 corrects the power-loss period Ts for the first rectifying element 41 based on the time xti and the time xto. The time xti at this time corresponds to the time when the second transformer voltage Vt2 is detected by the detection circuit 72. The time xto at this time corresponds to the time when the second transformer detection signal St2 corresponding to the second transformer voltage Vt2 detected by the detection circuit 72 is output from the detection circuit 72.

This suppresses a decrease in the accuracy of calculating the power-loss period Ts for the first rectifying element 41. This suppresses a decrease in the accuracy of calculating the quantity Td relating to the off-timing of the first rectifying element 41. Therefore, the variation in the timing at which the first rectifying element 41 in the on-state is turned off is suppressed. Therefore, the power loss caused by the first rectifying element 41 is suppressed.

The control circuit 74 corrects the power-loss period Ts for the second rectifying element 42 based on the times xgi and xgo. The time xgi at this time corresponds to the time when the second gate voltage Vgs2 is detected by the detection circuit 72. The time xgo at this time corresponds to the time when the second gate detection signal Sg2 corresponding to the second gate voltage Vgs2 detected by the detection circuit 72 is output from the detection circuit 72.

The control circuit 74 corrects the power-loss period Ts for the second rectifying element 42 based on the time xti and the time xto. The time xti at this time corresponds to the time when the detection circuit 72 detects the first transformer voltage Vt1. The time xto at this time corresponds to the time when the first transformer detection signal St1 corresponding to the first transformer voltage Vt1 detected by the detection circuit 72 is output from the detection circuit 72.

This suppresses a decrease in the accuracy of calculating the power-loss period Ts for the second rectifying element 42. Therefore, this suppresses a decrease in the accuracy of calculating the quantity Td relating to the off-timing of the second rectifying element 42. Accordingly, the variation in the timing at which the second rectifying element 42 is turned off in the on-state is suppressed. Thus, the power loss caused by the second rectifying element 42 is suppressed.

### Fifth Embodiment

In the fifth embodiment, the processing of the control circuit 74 differs from that in the first embodiment. The other configuration is the same as that of the first embodiment.

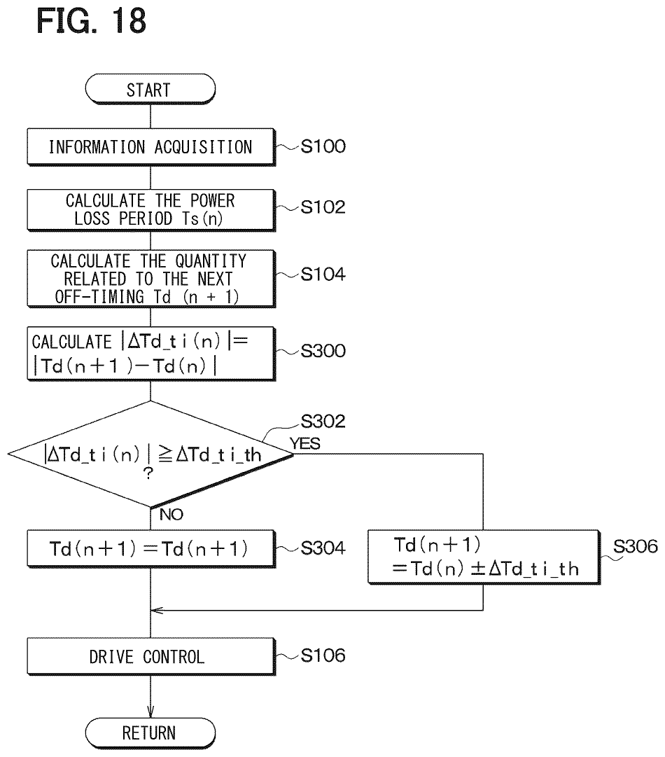

Specifically, as shown in the flowchart of FIG. 18, the control circuit 74 performs the processing from S100 to S104 in the same manner as in the first embodiment.

Here, if the quantity Td related to the off-timing changes rapidly between control cycles, the first rectifying element 41 and the second rectifying element 42 may be turned on during the on-prohibited period Ton_ban.

Therefore, in S300 following S104, the control circuit 74 calculates the change in the quantity Td related to the off-timing. Specifically, the control circuit 74 calculates the absolute value of the difference between the quantity Td(n+1) related to the next off-timing calculated in S104 and the quantity Td(n) related to the off-timing calculated in the previous control cycle. In this way, the control circuit 74 calculates the quantity of change over time |ΔTd_ti(n)|.

In S302 following S300, the control circuit 74 determines whether or not the quantity of change over time |ΔTd_ti(n)| calculated in S300 is equal to or greater than a change threshold value ΔTd_ti_th. This allows the control circuit 74 to determine whether or not the change in the quantity Td relating to the off-timing is abrupt. The change threshold value ΔTd_ti_th is set by experiment, simulation, or the like so that it is possible to determine whether or not a change in the quantity Td related to the off-timing is a sudden change.

When the quantity of change over time |ΔTd_ti(n)| is equal to or greater than the change threshold value ΔTd_ti_th, the change in the quantity Td related to the off-timing is abrupt. Therefore, at this time, the processing of the control circuit 74 proceeds to S306. When the quantity of change over time |ΔTd_ti(n)| is less than the change threshold value ΔTd_ti_th, the change in the quantity Td related to the off-timing is not a sudden change. Therefore, at this time, the processing of the control circuit 74 proceeds to S304.

In S304 following S302, the change in the quantity Td relating to the off-timing is not a sudden change. Therefore, the control circuit 74 keeps the quantity Td(n+1) relating to the next off-timing as the quantity Td(n+1) relating to the next off-timing calculated in S104. Thereafter, the processing of the control circuit 74 proceeds to S106.

In S306 following S302, since the change in the quantity Td relating to the off-timing is abrupt, the control circuit 74 corrects the quantity Td(n+1) relating to the next off-timing.

Specifically, the control circuit 74 substitutes the quantity Td(n) relating to the off-timing calculated in the previous control cycle and the change threshold value ΔTd_ti_th into the following equation (3). As a result, the control circuit 74 corrects the quantity Td(n+1) relating to the next off-timing. At this time, two quantities Td(n+1) related to the next off-timing are calculated, and the control circuit 74 selects the quantity Td(n+1) related to the next off-timing in which the first rectifying element 41 and the second rectifying element 42 are not turned on during the on-prohibited period T_on_ban. Thereafter, the processing of the control circuit 74 proceeds to S106.

$$Td ( n + 1 ) = Td ( n ) \pm Δ Td\_ti \_th \qquad ( 3 )$$

In S106, when turning off the first rectifying element 41 and the second rectifying element 42, the control circuit 74 outputs a signal to turn off each rectifying element based on the quantity Td(n+1) related to the off-timing calculated in S304 or S306. This prevents the first rectifying element 41 and the second rectifying element 42 from being turned on during the on-prohibited period T_on_ban.

As described above, the control circuit 74 of the power converter 10 according to the fifth embodiment executes processing. The fifth embodiment achieves effects similar to the effects achieved by the first embodiment. The fifth embodiment also achieves the following effects.

The control circuit 74 corrects the quantity Td related to the off-timing of the first rectifying element 41 and the second rectifying element 42 when the quantity of change over time |ΔTd_ti(n)| is equal to or larger than the change threshold value ΔTd_ti_th.

This prevents the first rectifying element 41 and the second rectifying element 42 from being turned on during the on-prohibited period T_on_ban.

### Sixth Embodiment

In a sixth embodiment, the processing of the control circuit 74 differs from that in the first embodiment. The other configuration is the same as that of the first embodiment.

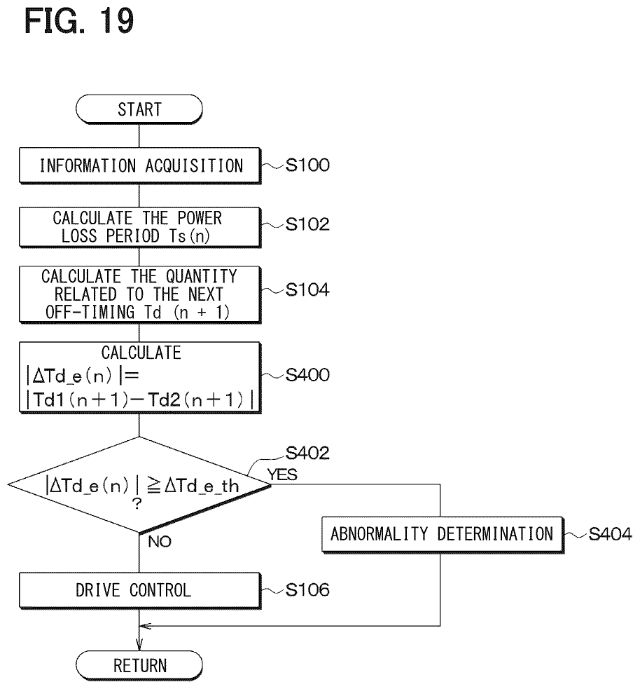

As shown in the flowchart of FIG. 19, the control circuit 74 executes processing from S100 to S102 in the same manner as in the first embodiment. In S104 following S102, the control circuit 74 calculates the quantity Td(n+1) relating to the next off-timing of the first rectifying element 41, similarly to the first embodiment. Furthermore, the control circuit 74 calculates the quantity Td(n+1) relating to the next off-timing of the second rectifying element 42, similarly to the first embodiment.

Here, the quantity Td relating to the off-timing of the first rectifying element 41 is set as an quantity Td1 relating to the first timing. The quantity Td relating to the off-timing of the second rectifying element 42 is set as an quantity Td2 relating to the second timing.

When the power converter 10 is normal, the first rectifying element 41 and the second rectifying element 42 are driven in the same manner, so the difference between the quantity Td1 relating to the first timing and the quantity Td2 relating to the second timing is small. However, if the difference between the quantity Td1 related to the first timing and the quantity Td2 related to the second timing is large, there is a high possibility that the power converter 10 is abnormal.

Therefore, in S400 following S104, the control circuit 74 calculates the absolute value of the difference between the quantity Td1(n+1) related to the first timing calculated in S104 and the quantity Td2(n+1) related to the second timing calculated in S104. As a result, the control circuit 74 calculates the timing difference |ΔTd_e(n) |.

In S402 following S400, the control circuit 74 determines whether or not the timing difference |ΔTd_e(n) | calculated in S400 is equal to or greater than a timing threshold value ΔTd_e_th. In this way, the control circuit 74 determines whether or not the difference between the quantity Td1 related to the first timing and the quantity Td2 related to the second timing is large. The timing threshold value ΔTd_e_th is set by, for example, experiment or simulation so as to determine whether or not the difference between the quantity Td1 related to the first timing and the quantity Td2 related to the second timing is large.

When the timing difference |ΔTd_e(n)| is less than the timing threshold value ΔTd_e_th, the difference between the quantity Td1 related to the first timing and the quantity Td2 related to the second timing is small. Therefore, at this time, the processing of the control circuit 74 proceeds to S106. In S106, when turning off the first rectifying element 41, the control circuit 74 outputs a signal to turn off the first rectifying element 41 based on the quantity Td1(n+1) related to the first timing calculated in S104. Furthermore, when turning off the second rectifying element 42, the control circuit 74 outputs a signal to turn off the second rectifying element 42 based on the quantity Td2(n+1) related to the second timing calculated in S104.

Furthermore, when the timing difference |ΔTd_e(n)| is equal to or larger than the timing threshold value ΔTd_e_th, the difference between the quantity Td1 related to the first timing and the quantity Td2 related to the second timing is large. Therefore, at this time, the processing of the control circuit 74 proceeds to S404.

In S404 following S402, the timing difference |ΔTd_e(n)| is equal to or larger than the timing threshold value ΔTd_e_th, so that the difference between the quantity Td1 related to the first timing and the quantity Td2 related to the second timing is large. At this time, therefore, the control circuit 74 determines that the power converter 10 is abnormal. Furthermore, the control circuit 74 stops the output of signals that turn on and off the first transistor 301, the second transistor 302, the third transistor 303, the fourth transistor 304, the first rectifying element 41, and the second rectifying element 42. The control circuit 74 also outputs an alarm using, for example, text display, sound, and light. Thereafter, the processing of the control circuit 74 returns to S100.

As described above, the control circuit 74 of the power converter 10 of the sixth embodiment executes processing. The sixth embodiment achieves effects similar to the effects achieved by the first embodiment. The sixth embodiment also achieves the following effects.

The control circuit 74 determines that the power converter 10 is abnormal when the timing difference |ΔTd_e(n) | is equal to or larger than the timing threshold value ΔTd_e_th. This makes it possible to determine whether or not the power converter 10 is abnormal.

### Seventh Embodiment

In a seventh embodiment, the processing of the control circuit 74 differs from that in the first embodiment. The other configuration is the same as that of the first embodiment.

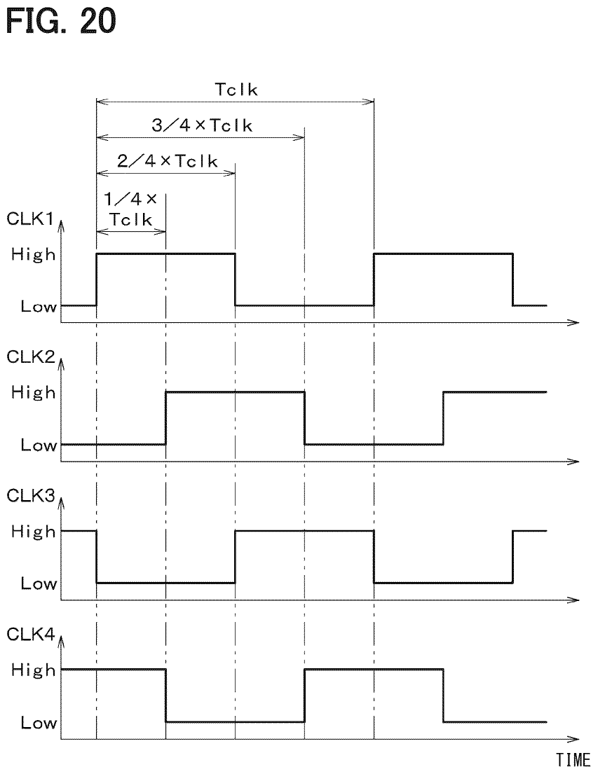

Specifically, the control circuit 74 generates multiple clock signals with different phases. For example, as shown in FIG. 20, the control circuit 74 generates a first clock signal CLK1, a second clock signal CLK2, a third clock signal CLK3, and a fourth clock signal CLK4.

Here, the period of the first clock signal CLK1 is set to Tclk. The phase difference between the first clock signal CLK1 and the second clock signal CLK2 is ¼×Tclk, that is, 90°. The phase difference between the first clock signal CLK1 and the third clock signal CLK3 is 2/4×Tclk, that is, 180°. The phase difference between the first clock signal CLK1 and the fourth clock signal CLK4 is ¾×Tclk, that is, 270°.

In S100, the control circuit 74 also obtains the first gate detection signal Sg1, for example, each time the voltage levels of the first clock signal CLK1, the second clock signal CLK2, the third clock signal CLK3, and the fourth clock signal CLK4 change. In S100, the control circuit 74 obtains the second gate detection signal Sg2 each time the voltage levels of the first clock signal CLK1, the second clock signal CLK2, the third clock signal CLK3, and the fourth clock signal CLK4 change. In S100, the control circuit 74 obtains the first transformer detection signal St1 each time time the voltage levels of the first clock signal CLK1, the second clock signal CLK2, the third clock signal CLK3, and the fourth clock signal CLK4 change. In S100, the control circuit 74 obtains the second transformer detection signal St2 each time the voltage levels of the first clock signal CLK1, the second clock signal CLK2, the third clock signal CLK3, and the fourth clock signal CLK4 change.

Therefore, in S100, the control circuit 74 obtains the first gate detection signal Sg1 multiple times with shifted timing using these generated clock signals. The control circuit 74 obtains the second gate detection signal Sg2 multiple times with different timings based on these generated clock signals. The control circuit 74 acquires the first transformer detection signal St1 multiple times with different timings based on these generated clock signals. The control circuit 74 acquires the second transformer detection signal St2 multiple times with shifted timing using these generated clock signals. The processing of S102 to S106 following S100 are performed in the same manner as in the first embodiment.

As described above, the control circuit 74 of the power converter 10 according to the seventh embodiment executes the processing. The seventh embodiment achieves effects similar to the effects achieved by the first embodiment. The seventh embodiment also achieves the following effects.

The control circuit 74 obtains the first gate detection signal Sg1 multiple times at different timings. The control circuit 74 obtains the second gate detection signal Sg2 multiple times at different timings. The control circuit 74 acquires the first transformer detection signal St1 multiple times at different timings. The control circuit 74 obtains the second transformer detection signal St2 multiple times at different timings.

This improves the time resolution of the control circuit 74 in acquiring the first gate detection signal Sg1, the second gate detection signal Sg2, the first transformer detection signal St1, and the second transformer detection signal St2. This suppresses a decrease in accuracy of the first gate detection signal Sg1, the second gate detection signal Sg2, the first transformer detection signal St1, and the second transformer detection signal St2. This suppresses a decrease in the calculation accuracy of the power-loss period Ts calculated using the first gate detection signal Sg1, the second gate detection signal Sg2, the first transformer detection signal St1, and the second transformer detection signal St2. This suppresses a decrease in the accuracy of calculating the quantity Td relating to the off-timing.

### Eighth Embodiment

An eighth embodiment is different from the first embodiment in the form of the detection circuit 72. Furthermore, the processing of the control circuit 74 differs from that of the first embodiment. The other configurations are similar to those of the first embodiment.

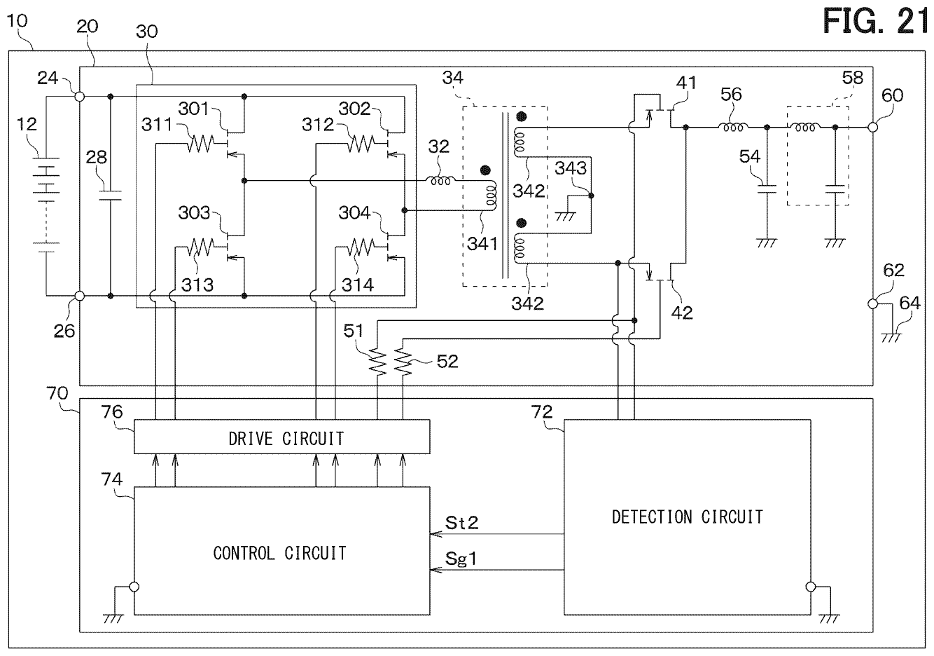

As shown in FIG. 21, the detection circuit 72 detects the second transformer voltage Vt2 and the first gate voltage Vgs1, but does not detect the first transformer voltage Vt1 and the second gate voltage Vgs2. Therefore, the detection circuit 72 does not include the first transformer voltage detection unit 721, the first transformer voltage comparator 731, the second gate voltage detection unit 742, and the second gate voltage comparator 752.

Since the detection circuit 72 does not detect the first transformer voltage Vt1 and the second gate voltage Vgs2, the quantity Td related to the off-timing of the second rectifying element 42 cannot be calculated using the first transformer voltage Vt1 and the second gate voltage Vgs2. However, as described above, the difference between the quantity Td relating to the off-timing of the first rectifying element 41 and the quantity Td relating to the off-timing of the second rectifying element 42 is small. Therefore, the quantity Td relating to the off-timing of the first rectifying element 41 and the quantity Td relating to the off-timing of the second rectifying element 42 are substantially the same.

Therefore, when turning off the second rectifying element 42 in S106, the control circuit 74 outputs a signal to turn off the second rectifying element 42 based on the quantity Td related to the off-timing of the first rectifying element 41.

The power converter 10 according to the eighth embodiment is configured as described above, and the control circuit 74 executes processing. The eighth embodiment achieves effects similar to the effects achieved by the first embodiment.

### Ninth Embodiment

A ninth embodiment is different from the first embodiment in the form of the detection circuit 72. Furthermore, the processing of the control circuit 74 differs from that of the first embodiment. The other configurations are similar to those of the first embodiment.

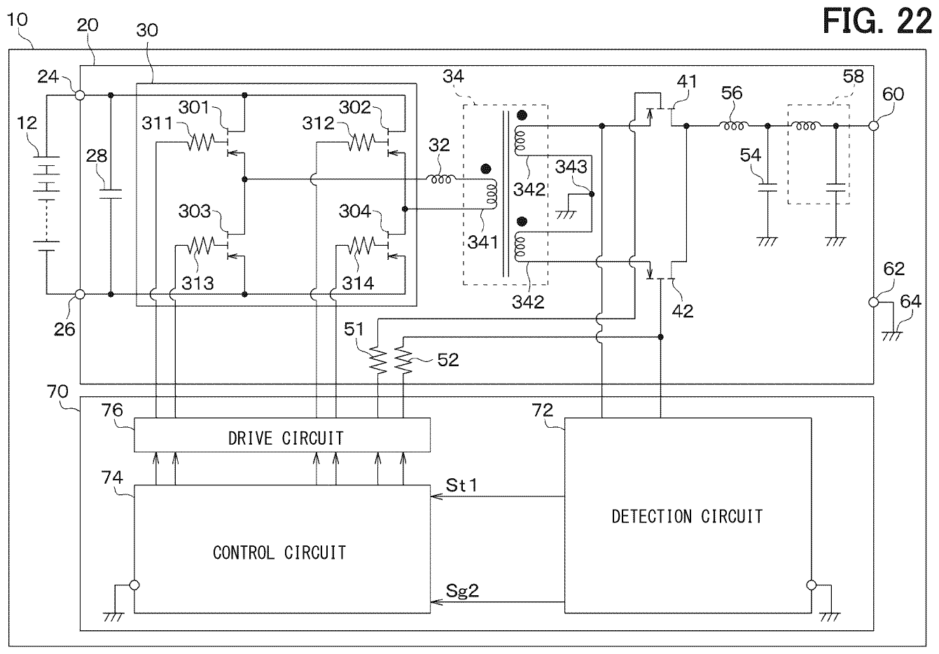

As shown in FIG. 22, the detection circuit 72 detects the first transformer voltage Vt1 and the second gate voltage Vgs2, but does not detect the second transformer voltage Vt2 and the first gate voltage Vgs1. Therefore, the detection circuit 72 does not include the second transformer voltage detection unit 722, the second transformer voltage comparator 732, the first gate voltage detection unit 741, and the first gate voltage comparator 751.

Since the detection circuit 72 does not detect the second transformer voltage Vt2 and the first gate voltage Vgs1, the quantity Td related to the off-timing of the first rectifying element 41 cannot be calculated using the second transformer voltage Vt2 and the first gate voltage Vgs1. However, as described above, the quantity Td relating to the off-timing of the first rectifying element 41 and the quantity Td relating to the off-timing of the second rectifying element 42 are substantially the same.

Therefore, when turning off the first rectifying element 41 in S106, the control circuit 74 outputs a signal to turn off the first rectifying element 41 based on the quantity Td related to the off-timing of the second rectifying element 42.

The power converter 10 according to the ninth embodiment is configured as described above, and the control circuit 74 executes processing. The ninth embodiment achieves effects similar to the effects achieved by the first embodiment.

### Tenth Embodiment

A tenth embodiment is different from the first embodiment in the form of the detection circuit 72. Furthermore, the processing of the control circuit 74 differs from that of the first embodiment. The other configurations are similar to those of the first embodiment.

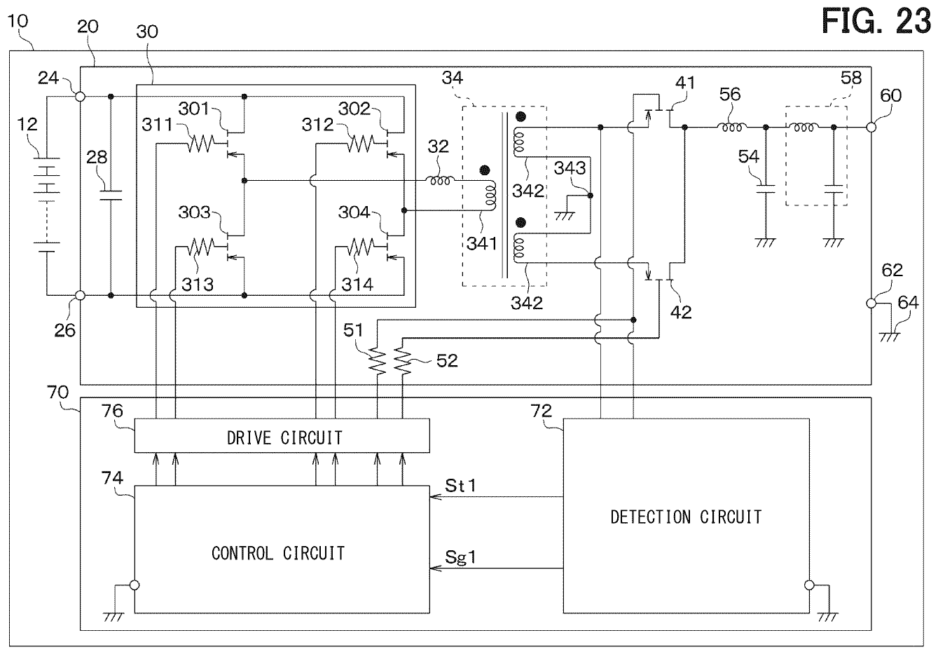

As shown in FIG. 23, the detection circuit 72 detects the first transformer voltage Vt1 and the first gate voltage Vgs1, but does not detect the second transformer voltage Vt2 and the second gate voltage Vgs2. Therefore, the detection circuit 72 does not include the second transformer voltage detection unit 722, the second transformer voltage comparator 732, the second gate voltage detection unit 742, and the second gate voltage comparator 752.

Here, since the second transformer voltage Vt2 is not detected by the detection circuit 72, the quantity Td relating to the off-timing of the first rectifying element 41 cannot be calculated using the second transformer voltage Vt2 and the first gate voltage Vgs1. However, the second transformer voltage Vt2 is a voltage whose positive and negative polarities are different from those of the first transformer voltage Vt1. Furthermore, the absolute value of the second transformer voltage Vt2 is the same as the absolute value of the first transformer voltage Vt1.

For this reason, the detection circuit 72 has a NOT circuit (not shown) or the like, and inverts the positive and negative of the first transformer voltage Vt1. As a result, the first transformer detection signal St1 output from the detection circuit 72 becomes the same as the second transformer detection signal St2.

Therefore, in S102, the control circuit 74 calculates the power-loss period Ts for the first rectifying element 41 based on the first transformer detection signal St1 and the first gate detection signal Sg1. Furthermore, in S104, the control circuit 74 calculates an quantity Td relating to the off-timing of the first rectifying element 41 based on the calculated power-loss period Ts for the first rectifying element 41. In S106, when turning off the first rectifying element 41, the control circuit 74 outputs a signal to turn off the first rectifying element 41 based on the calculated quantity Td related to the off-timing of the first rectifying element 41.

As described above, the quantity Td relating to the off-timing of the first rectifying element 41 and the quantity Td relating to the off-timing of the second rectifying element 42 are substantially the same.

Therefore, in S106, when turning off the second rectifying element 42, the control circuit 74 outputs a signal to turn off the second rectifying element 42 based on the quantity Td related to the off-timing of the first rectifying element 41 calculated as described above.

As described above, the power converter 10 according to the tenth embodiment is configured, and the control circuit 74 executes processing. The tenth embodiment achieves effects similar to the effects achieved by the first embodiment.

### Eleventh Embodiment

An eleventh embodiment is different from the first embodiment in the form of the detection circuit 72. The processing of the control circuit 74 differs from that of the first embodiment. The other configurations are similar to those of the first embodiment.

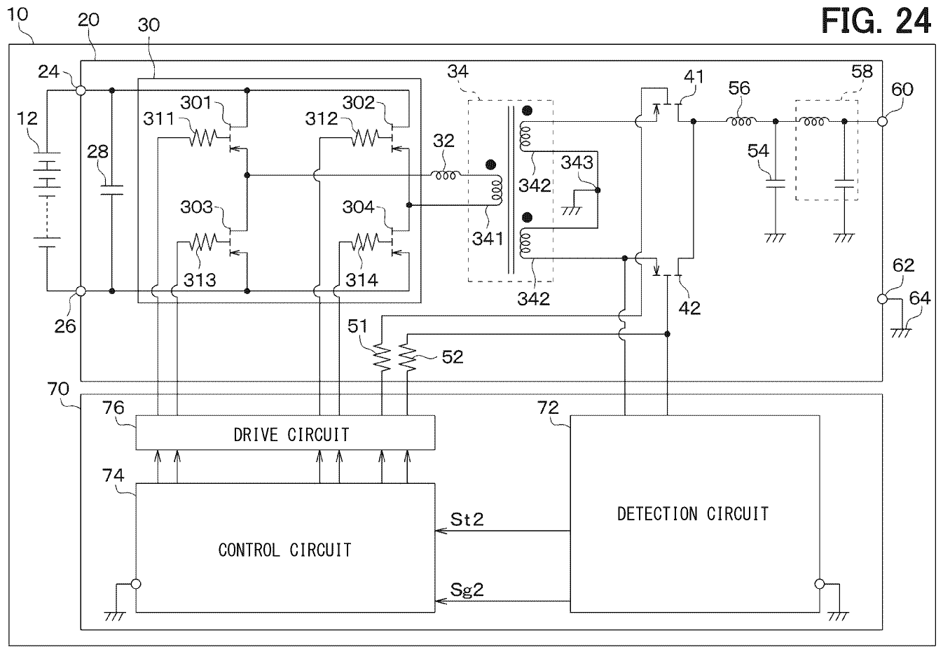

As shown in FIG. 24, the detection circuit 72 detects the second transformer voltage Vt2 and the second gate voltage Vgs2, but does not detect the first transformer voltage Vt1 and the first gate voltage Vgs1. Therefore, the detection circuit 72 does not include the first transformer voltage detection unit 721, the first transformer voltage comparator 731, the first gate voltage detection unit 741, and the first gate voltage comparator 751.

As described above, the first transformer voltage Vt1 is a voltage whose positive and negative polarities are different from those of the second transformer voltage Vt2. Furthermore, the absolute value of the first transformer voltage Vt1 is the same as the absolute value of the second transformer voltage Vt2.

For this reason, the detection circuit 72 has a NOT circuit (not shown) or the like, thereby inverting the polarity of the second transformer voltage Vt2. As a result, the second transformer detection signal St2 output from the detection circuit 72 becomes similar to the first transformer detection signal St1.

Therefore, in 102, the control circuit 74 calculates the power-loss period Ts for the second rectifying element 42 based on the second transformer detection signal St2 and the second gate detection signal Sg2. In S104, the control circuit 74 calculates an quantity Td relating to the off-timing of the second rectifying element 42 based on the calculated power-loss period Ts for the second rectifying element 42. In S106, when turning off the second rectifying element 42, the control circuit 74 outputs a signal to turn off the second rectifying element 42 based on the calculated quantity Td related to the off-timing of the second rectifying element 42.

As described above, the quantity Td relating to the off-timing of the first rectifying element 41 and the quantity Td relating to the off-timing of the second rectifying element 42 are substantially the same.

Therefore, when the control circuit 74 turns off the first rectifying element 41 in 106, the control circuit 74 outputs a signal to turn off the first rectifying element 41 based on the quantity Td related to the off-timing of the second rectifying element 42 calculated above.

The power converter 10 according to the eleventh embodiment is configured as described above, and the control circuit 74 executes processing. The eleventh embodiment achieves effects similar to the effects achieved by the first embodiment.

### OTHER EMBODIMENTS

The present disclosure is not limited to the above-described embodiments, and the above-described embodiments can be appropriately modified. The constituent element(s) of each of the above embodiments is/are not necessarily essential unless it is specifically stated that the constituent element(s) is/are essential in the above embodiment, or unless the constituent element(s) is/are obviously essential in principle.

The detection unit, the control unit, and the methods thereof described in the present disclosure may be realized by a dedicated computer provided by configuring a processor, programmed to execute one or more functions embodied by a computer program, and a memory. Alternatively, the detection unit, the control unit, and the methods thereof described in the present disclosure may be realized by a dedicated computer provided by configuring a processor with one or more dedicated hardware logic circuits. Alternatively, the detection unit, the control unit, and the methods thereof described in the present disclosure may be realized by one or more dedicated computers configured by a combination of a processor programmed to execute one or more functions, a memory, and a processor configured by one or more hardware logic circuits. The computer program may be stored in a computer-readable non-transitory tangible recording medium as an instruction executed by the computer.

In each of the above embodiments, the power converter 10 is a DC-DC converter for a vehicle. On the other hand, the power converter 10 is not limited to being used in a vehicle, and may be used in, for example, equipment.

In each of the above embodiments, the conversion circuit 30 is a full-bridge inverter circuit. On the other hand, the conversion circuit 30 is not limited to being a full-bridge inverter circuit, and may be, for example, a push-pull inverter circuit or a half-bridge inverter circuit.

In each of the above embodiments, the first transistor 301, the second transistor 302, the third transistor 303 and the fourth transistor 304 are field-effect transistors (FETs). On the other hand, the first transistor 301, the second transistor 302, the third transistor 303, and the fourth transistor 304 are not limited to being FETs, and may be, for example, insulated gate bipolar transistors (IGBTs).

In each of the above embodiments, the transformer 34 steps down the AC voltage from the conversion circuit 30. In contrast, the transformer 34 may step up the AC voltage from the conversion circuit 30.

In each of the above embodiments, the first rectifying element 41 and the second rectifying element 42 are transistors, that is, FETs. On the other hand, the first rectifying element 41 and the second rectifying element 42 are not limited to being FETs, and may be transistors such as IGBTs.

In each of the above embodiments, the control circuit 74 calculates the quantity Td relating to the off-timing of each rectifying element based on the voltage between the transformer 34 and each rectifying element and the gate voltage of each rectifying element. In contrast, the control circuit 74 may calculate the quantity Td relating to the off-timing of each rectifying element based only on the voltage between the transformer 34 and each rectifying element. For example, the control circuit 74 calculates the quantity Td related to the off-timing of each rectifying element, which is the period from when a signal is output to turn each rectifying element from off to on to when the voltage between the transformer 34 and each rectifying element becomes equal to or greater than the transformer voltage threshold Vt_th. This allows the control circuit 74 to determine the quantity Td relating to the off-timing of each rectifying element without using the gate voltage of each rectifying element.

In each of the above embodiments, the number of rectifying elements is two. On the other hand, the number of rectifying elements may be one, or three or more.

In each of the above embodiments, the main circuit 20 has the magnetic component 32. In contrast, the main circuit 20 does not need to include the magnetic component 32.

The above-described embodiments may be combined as appropriate.

What is claimed is:

1. A power converter comprising:
a converter configured to convert a DC voltage into an AC voltage, the DC voltage supplied from a DC power supply;
a transformer configured to step up or down the AC voltage;
a rectifying element being a transistor, the rectifying element configured to rectify the AC voltage that is stepped up or down by the transformer;
a detector configured to detect a transformer voltage between the transformer and the rectifying element; and
a controller configured to turn off the rectifying element in an on-state, based on the transformer voltage.

2. The power converter according to claim 1, wherein
the detector is configured to detect a gate voltage of the rectifying element, and
the controller is configured to:
calculate a quantity related to off-timing based on the gate voltage and the transformer voltage, the off-timing being a timing of turning off the rectifying element in the on-state; and
turn off the rectifying element in the on-state, based on the quantity that is calculated by the controller.

3. The power converter according to claim 2, wherein
the controller is configured to calculate the quantity related to the off-timing, based on a power-loss period between a first time and a second time,
the first time is a time at which the gate voltage transitions from a value equal to or larger than a gate voltage threshold to a value smaller than the gate voltage threshold, and
the second time is a time at which an absolute value of the transformer voltage transitions from a value smaller than a transformer voltage threshold to a value equal to or larger than the transformer voltage threshold.

4. The power converter according to claim 3, wherein
the controller is configured to:
calculate the quantity related to the off-timing of a next occasion, based on
the power-loss period that is associated with a present cycle and a cycle before the present cycle, and
the quantity related to the off-timing that is associated with the present cycle and the cycle before the present occasion; and
turn off the rectifying element that is in the on-state in the next occasion, based on the calculated quantity of the next occasion.

5. The power converter according to claim 4, wherein
the controller is configured to correct the quantity related to the off-timing of the next occasion, in a case where an absolute value of a difference between the quantity of the next occasion and the quantity that is associated with the present occasion and the occasion before the present occasion is equal to or larger than a change threshold.

6. The power converter according to claim 3, wherein
the controller is configured to:
output a signal that drives the converter and a signal that turns the rectifying element on and off; and
calculate the power-loss period according to the gate voltage during a duration,
the duration is determined based on
a change in a level of the signal that drives the converter, and
a change in a level of the signal that turns the rectifying element on and off.

7. The power converter according to claim 6, wherein
the controller is configured to determine that the power converter is abnormal, in a case where the gate voltage does not transition from the value equal to or larger than the gate voltage threshold to the value smaller than the gate voltage threshold during the duration.

8. The power converter according to claim 6, wherein
the converter has a transistor,
the transistor is configured to convert the DC voltage into the AC voltage by being turned on and off,
the controller is configured to output a signal that turns the transistor on and off,
the duration spans from a first time point to a second time point,
the first time point is a time point at which the controller outputs a signal that turns the rectifying element from on to off, and
the second time point is a time point at which the controller outputs a signal that turns the transistor of the converter from off to on.

9. The power converter according to claim 3, wherein
the controller is configured to:
output a signal that drives the converter; and
calculate the power-loss period, according to the transformer voltage during a duration that is based on a change in a level of a signal that drives the converter.

10. The power converter according to claim 9, wherein
the controller is configured to determine that the power converter is abnormal, in a case where the transformer voltage does not transition from a value smaller than the transformer voltage threshold to a value larger than or equal to the transformer voltage threshold during the duration.

11. The power converter according to claim 9, wherein
the converter includes a first transistor and a second transistor,
the first transistor and the second transistor are configured to convert the DC voltage to the AC voltage by being turned on and off, the DC voltage supplied from the DC power supply,
the controller is configured to output a signal that turns on and off the first transistor and the second transistor,
the duration spans from a first time point to a second time point,
the first time point is a time point at which the controller outputs a signal that turns the first transistor from on to off, and
the second time point is a time point at which the controller outputs a signal that turns the second transistor from off to on.

12. The power converter according to claim 9, wherein
the duration includes:
first time points at which an absolute value of the transformer voltage transitions from a value smaller than the transformer voltage threshold to a value larger than or equal to the transformer voltage threshold,
second time points at which the absolute value transitions from the value larger than or equal to the transformer voltage threshold to the value smaller than the transformer voltage threshold after the first time points, and
time intervals spanning from the first time points to the second time points, and
the controller is configured to calculate the power-loss period, based on a first time point of a longest time interval among the time interval.

13. The power converter according to claim 9, wherein
the duration includes:
the first time points at which an absolute value of the transformer voltage transitions from a value smaller than the transformer voltage threshold to a value larger than or equal to the transformer voltage threshold,
the second time points at which the absolute value transitions from the value larger than or equal to the transformer voltage threshold to the value smaller than the transformer voltage threshold after the first time points,
time intervals spanning from the first time points to the second time points, and
the controller is configured to:
select one or more time intervals among the time intervals, the selected time interval being longer than a resonance period being set based on an inductance of the transformer and a capacitance of the rectifying element; and
calculate the power-loss period, based on an earliest one of the selected time intervals.

14. The power converter according to claim 3, wherein
the detector is configured to:
output a gate detection signal to the controller, the gate detection signal corresponding to the gate voltage; and
change a level of the gate detection signal, in a case where the gate voltage transitions from the value equal to or larger than the gate voltage threshold to the value smaller than the gate voltage threshold, and
the controller is configured to correct the power-loss period, based on
a time point where the gate voltage is detected by the detector, and
a time point where the gate detection signal is output from the detector.

15. The power converter according to claim 3, wherein
the detector is configured to:
output a transformer detection signal to the controller, the transformer detection signal corresponding to the transformer voltage; and
change a level of the transformer detection signal in a case where the transformer voltage transitions from the value smaller than the transformer voltage threshold to the value larger than or equal to the transformer voltage threshold, and
the controller is configured to correct the power-loss period based on
a time point at which the transformer voltage is detected by the detector, and
a time point at which the transformer detection signal is output from the detector.

16. The power converter according to claim 3, wherein
the detector is configured to:
output a gate detection signal to the controller, the gate detection signal corresponding to the gate voltage; and
change a level of the gate detection signal, in a case where the gate voltage transitions from the value equal to or larger than the gate voltage threshold to the value smaller than the gate voltage threshold, and
the controller is configured to acquire the gate detection signal a plurality of times at different timings.

17. The power converter according to claim 3, wherein
the detector is configured to:
output a transformer detection signal to the controller, the transformer detection signal corresponding to the transformer voltage; and
change a level of the transformer detection signal in a case where the transformer voltage transitions from the value smaller than the transformer voltage threshold to the value larger than or equal to the transformer voltage threshold, and
the controller is configured to acquire the transformer detection signal a plurality of times at different timings.

18. The power converter according to claim 2, wherein
the rectifying element is a first rectifying element,
the gate voltage is a first gate voltage,
the quantity related to the off-timing is a quantity related to a first timing,
the power converter further comprises a second rectifying element,
the second rectifying element is a transistor and rectifies the AC voltage stepped up or down by the transformer,
the detector detects a second gate voltage of the second rectifying element, and
the controller is configured to:
calculate a quantity related to a second timing based on the second gate voltage and the transformer voltage, the second timing being a timing of turning off the second rectifying element that is in the on-state; and
turn off the second rectifying element in the on-state based on the calculated quantity related to the second timing.

19. The power converter according to claim 18, wherein
the controller is configured to determine that the power converter is abnormal, in a case where an absolute value of a difference between the quantity related to the first timing and the quantity related to the second timing is equal to or larger than a timing threshold.
